(19) United States
(12) Patent Application Publication
(10) Pub. No.: US 2025/0386191 A1
(43) Pub. Date: Dec. 18, 2025

(54) CBRS-BASED PRIVATE WIRELESS NETWORK HUB

(71) Applicant: Apple Inc., Cupertino, CA (US)

(72) Inventors: Raj S. CHAUGULE, Santa Clara, CA (US); Hyewon LEE, Cupertino, CA (US); Arnab ROY, San Diego, CA (US); Kenza HAMIDOUCHE, Cupertino, CA (US); Ayman F. NAGUIB, Cupertino, CA (US)

(21) Appl. No.: 19/179,176

(22) Filed: Apr. 15, 2025

Related U.S. Application Data
(60) Provisional application No. 63/652,253, filed on May 28, 2024.

(51) Int. Cl. H04W 12/08; H04W 8/00; H04W 8/18; H04W 12/041

(52) U.S. Cl. CPC H04W 12/08; H04W 8/005; H04W 8/18; H04W 12/041

(57) ABSTRACT

This Application describes managing access to a Citizens Band Radio Service (CBRS) private wireless network that is maintained by a CBRS wireless network hub. A CBRS wireless node associates with the CBRS wireless network hub and obtains an electronic subscriber identity module (eSIM) to connect to the CBRS private wireless network. The eSIM is generated by the CBRS wireless network hub or by a cloud-network server using a one-time public key (otPK) obtained from the CBRS wireless node. The CBRS wireless node can authenticate before obtaining the eSIM based on i) having a common cloud-network service account or a different cloud-network service account of the cloud-network server as the CBRS wireless network hub, or ii) by using a mutual authentication procedure. The eSIM can be revoked and stored at the CBRS wireless network hub for subsequent re-use with the CBRS wireless node.

### CROSS-REFERENCE TO RELATED APPLICATIONS

The present application claims the benefit of U.S. Provisional Application No. 63/652,253, entitled “CBRS-BASED PRIVATE WIRELESS NETWORK HUB,” filed May 28, 2024, the content of which is incorporated by reference herein in its entirety for all purposes.

### FIELD

The described embodiments set forth techniques for managing access to a Citizens Band Radio Service (CBRS) private wireless network managed by a wireless network hub. A CBRS device (CBSD) associates with the wireless network hub, obtains an electronic subscriber identity module (eSIM), and uses credentials of the eSIM to connect to the CBRS private wireless network.

### BACKGROUND

Many cellular wireless devices use credentials of removable Universal Integrated Circuit Cards (UICCs) that include a microprocessor and a read-only memory (ROM), where the ROM is configured to store a mobile network operator (MNO) profile that the wireless device can use to register and interact with an MNO to obtain wireless services via a cellular wireless network of the MNO. enable the wireless devices to access services provided by Mobile Network Operators (MNOs). A profile may also be referred to as subscriber identity module (SIM). Typically, a UICC takes the form of a small removable card, commonly referred to as a SIM card, which is inserted into a UICC-receiving bay of a wireless device. In more recent implementations, UICCs are being embedded directly into system boards of wireless devices as embedded UICCs (eUICCs), which can provide advantages over traditional, removable UICCs. The eUICCs can include a rewritable memory that can facilitate installation, modification, and/or deletion of one or more electronic SIMs (eSIMs) on the eUICC, where the eSIMs can provide for new and/or different services and/or updates for accessing extended features provided by MNOs. An eUICC can store a number of MNO profiles—also referred to herein as eSIMs—and can eliminate the need to include UICC-receiving bays in wireless devices. More recently, integrated SIMs (iSIMs) have been proposed as a type of SIM that integrates directly into device hardware, e.g., a device processor and/or attached memory and/or a system on a chip (SoC) component, without use of a separate eUICC to store the iSIM. Whether in the form of a physical SIM (pSIM), an eSIM, or an iSIM, the MNO profile allows the wireless device to connect to and access services of a wireless network.

Computing devices configured for non-cellular wireless communication, e.g., via a wireless personal area network (WPAN), such as a Bluetooth WPAN, and/or via a wireless local area network (WLAN), such as a Wi-Fi WLAN, may also support cellular wireless communication in some cases. Present radio frequency (RF) bands used for non-cellular wireless communication, such as the 2.4 GHz and 5.0 GHz bands, can be supplemented with previously closed RF bands opened for general access use by personal wireless devices. One such RF band is the Citizens Broadband Radio Service (CBRS) that offers shared use of a 3.5 GHz band to personal wireless devices while retaining incumbent prioritized use for incumbent users and licensed users. The CBRS band offers additional spectrum to supplement existing wireless capabilities for personal wireless devices.

### SUMMARY

This Application sets forth techniques for managing access to a Citizens Band Radio Service (CBRS) private wireless network that is maintained by a CBRS wireless network hub. A CBRS wireless node can associate with the CBRS wireless network hub and obtain an electronic subscriber identity module (eSIM) to connect to the CBRS private wireless network. The eSIM can be generated by the CBRS wireless network hub or by a cloud-network server using a one-time public key (otPK) obtained from the CBRS wireless node. The CBRS wireless node can authenticate with the CBRS wireless network hub before obtaining the eSIM i) based on sharing a common cloud-network service account with the CBRS wireless network hub, ii) based on having a different cloud-network service account of the cloud-network server as the CBRS wireless network hub, or iii) by using a mutual authentication procedure between the CBRS wireless network hub and the CBRS wireless node. The eSIM includes credentials to allow the CBRS wireless node to connect to and communicate via the CBRS private wireless network. The CBRS wireless network hub can use a first software stack and cellular wireless hardware to implement a first cellular connection to a cellular wireless network, to use for cellular wireless backhaul of data packets to and from the CBRS private wireless network and the cellular wireless network. The CBRS wireless network hub can also use a second software stack and cellular wireless hardware to implement the CBRS private wireless network with connections to one or more CBRS wireless nodes. The CBRS wireless network hub can further implement efficient data packet routing at a baseband layer to differentiate data traffic that is local to the CBRS wireless network hub from data traffic to transport via the cellular wireless backhaul. The CBRS wireless network hub can implement a traffic scheduler to allow multiple CBRS wireless nodes to connect to the CBRS private wireless network and to reduce interference between them for communication via the CBRS private wireless network. The eSIM issued to the CBRS wireless node can be revoked and stored at the CBRS wireless network hub or at the cloud-network server for subsequent re-use by the CBRS wireless node to access the CBRS private wireless network.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of exemplary components of the system of FIG. 1, according to some embodiments.

FIG. 3A illustrates an overview diagram of the Citizens Broadband Radio Service (CBRS) radio frequency (RF) spectrum, according to some embodiments.

FIG. 3B illustrates a state diagram for registration of a CBRS device (CBSD), according to some embodiments.

FIG. 3C illustrates a state diagram for obtaining and maintaining a CBRS access grant, according to some embodiments.

FIG. 3D illustrates a block diagram of exemplary interfaces for a CBRS network, according to some embodiments.

FIG. 4 illustrates exemplary uses cases of CBRS for personal wireless devices, according to some embodiments.

FIG. 5A illustrates a block diagram of an example of using a CBRS private wireless network for cellular tethering a CBRS wireless node via a CBRS wireless network hub, according to some embodiments.

FIG. 5B illustrates a block diagram of an example of using a CBRS private wireless network hub in a wireless local area network (WLAN), according to some embodiments.

FIG. 6A illustrates a block diagram of an example of access management for a CBRS wireless network hub, according to some embodiments.

FIG. 6B illustrates a block diagram of an exemplary architecture of a CBRS wireless network hub, according to some embodiments.

FIG. 7A illustrates a flow diagram of an example of a network discovery stage in a call flow for adding a wireless node to a CBRS private wireless network, according to some embodiments.

FIG. 7B illustrates a flow diagram of an example of a credential provisioning stage in a call flow for adding a wireless node to a CBRS private wireless network, according to some embodiments.

FIG. 7C illustrates a flow diagram of an example of a credential deletion stage of a call flow for removing a wireless node from a CBRS private wireless network, according to some embodiments.

FIGS. 8A and 8B illustrate flow diagrams of another example of adding a wireless node to a CBRS private wireless network, according to some embodiments.

FIGS. 9A and 9B illustrate flowcharts of exemplary methods performed by one or more components of a CBRS wireless network hub, according to some embodiments.

FIG. 10 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

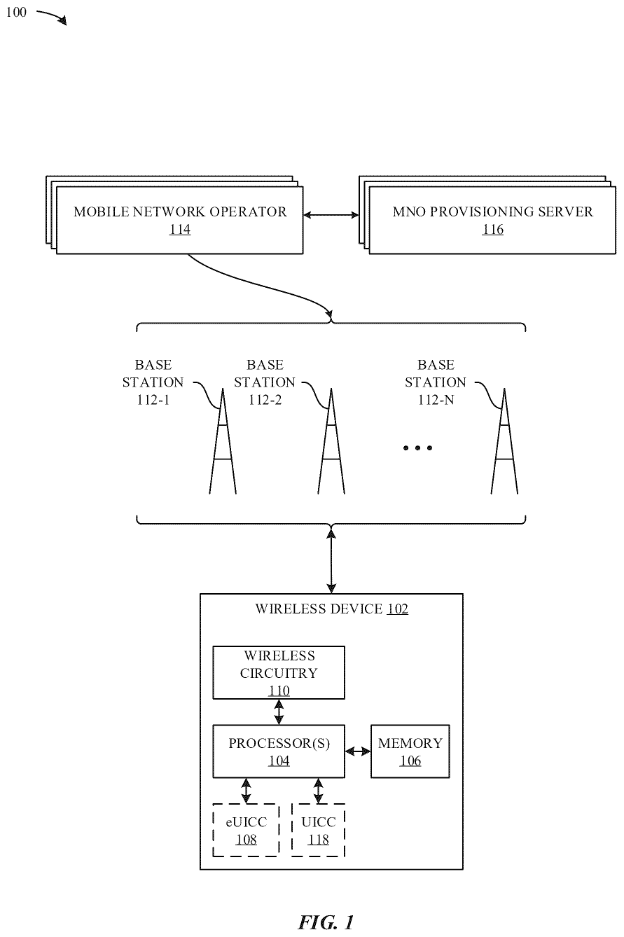

These and other embodiments are discussed below with reference to FIGS. 1-10; however, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a wireless device 102, which can also be referred to as a device, a mobile wireless device, a mobile device, a user equipment (UE) and the like, a group of base stations 112-1 to 112-N that are managed by different Mobile Network Operators (MNOs) 114, and a set of MNO provisioning servers 116 that are in communication with the MNOs 114. Additional MNO infrastructure servers, such as used for account management and billing are not shown. The wireless device 102 can represent a cellular-capable computing device (e.g., an iPhone® or an iPad® by Apple®) or a cellular-capable wearable device (e.g., an Apple Watch), the base stations 112-1 to 112-n can represent cellular wireless network entities, including evolved NodeBs (eNodeBs or eNBs) for fourth generation (4G) long term evolution (LTE) wireless networks and/or next generation NodeBs (gNodeBs or gNB) for fifth generation (5G) wireless networks (or comparable nodes for future generation wireless networks), where the cellular wireless network entities are configured to communicate with the wireless device 102, and the MNOs 114 can represent different wireless service providers that provide specific cellular wireless services (e.g., voice and data) to which the wireless device 102 can subscribe, such as via a cellular wireless service subscription account for a user of the wireless device 102.

As shown in FIG. 1, the wireless device 102 can include processing circuitry, which can include one or more processor(s) 104 and a memory 106, and baseband wireless circuitry 110 used for transmission and reception of cellular wireless radio frequency signals. The baseband wireless circuitry 110 can include analog hardware components, such as antennas and amplifiers, as well as digital processing components, such as signal processors (and/or general/limited purpose processors) and associated memory. In some embodiments, the wireless device 102 includes an embedded universal integrated circuit card (eUICC) 108 for storing one or more electronic SIMs (eSIMs). In some embodiments, the wireless device 102 includes one or more integrated SIMs (iSIMs) stored securely in hardware of the wireless device 102, e.g., in a processor (104), in memory (106), or in a system on a chip (SoC) component. In some embodiments, the wireless device 102 includes one or more physical UICCs 118, also referred to as Subscriber Identity Module (SIM) cards, in addition to or substituting for one or more eSIMs on the eUICC 108 or one or more iSIMs stored in hardware of the wireless device 102. The components of the wireless device 102 work together to enable the wireless device 102 to provide useful features to a user of the wireless device 102, such as cellular wireless network access, non-cellular wireless network access, localized computing, location-based services, and Internet connectivity. The eUICC 108 can be configured to store multiple electronic SIMs (eSIMs) for accessing cellular wireless services provided by different MNOs 114 by connecting to their respective cellular wireless networks through a base station 112 (or via multiple base stations 112), such as one or more of the base stations 112-1 to 112-N illustrated. For example, the eUICC 108 can be configured to store and manage one or more eSIMs for one or more MNOs 114 for different cellular wireless service subscriptions to which the wireless device 102 is subscribed. To be able to access cellular wireless services provided by an MNO 114, can be eSIM reserved for download and installation to the eUICC 108. The eUICC 108 can store one or more eSIMs obtained from one or more associated MNO provisioning servers 116. An MNO provisioning server 116 can be maintained by a manufacturer of the wireless device 102, by an MNO 114, by a third party entity, or the like. Communication of eSIM data between an MNO provisioning server 116 and the eUICC 108 (or between the MNO provisioning server 116 and processing circuitry of the wireless device 102 external to the eUICC 108, e.g., the processor 104) can use a secure communication channel. Similarly, one or more iSIMs can be stored securely in hardware of the wireless device 102 to enable access to cellular wireless services. Switching a cellular wireless service subscription between different wireless devices 102 as described herein can be accomplished using any combination of SIMs, eSIMs, or iSIMs on a set of wireless devices 102.

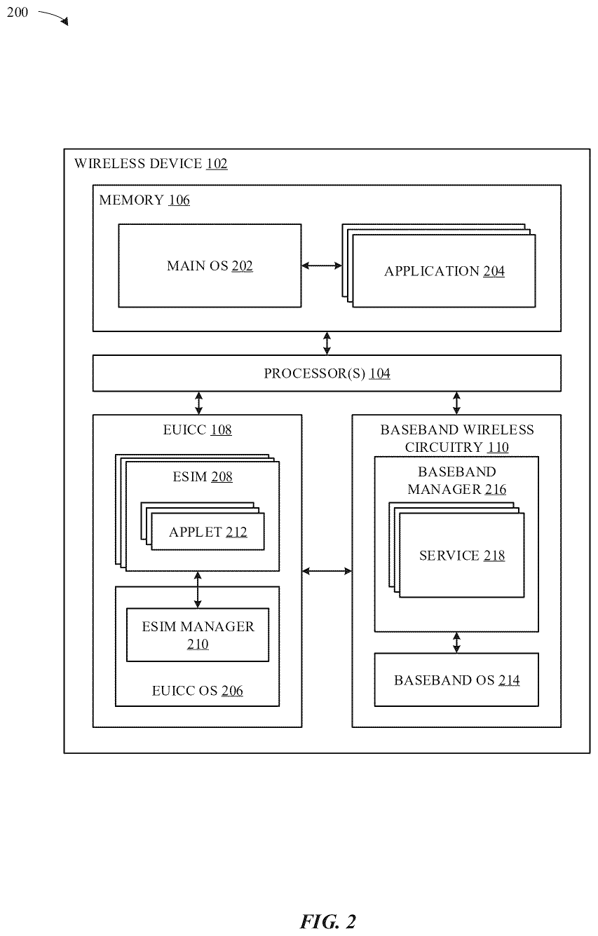

FIG. 2 illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIMs 208 that are stored by the eUICC 108, e.g., by downloading, installing, deleting, enabling, disabling, modifying, or otherwise performing management of the eSIMs 208 within the eUICC 108 and providing baseband wireless circuitry 110 with access to the eSIMs 208 to provide access to cellular wireless services for the wireless device 102. The eUICC 108 OS can include an eSIM manager 210, which can perform management functions for various eSIMs 208. According to the illustration shown in FIG. 2, each eSIM 208 can include a number of applets 212 that define the manner in which the eSIM 208 operates. For example, one or more of the applets 212, when implemented in conjunction with baseband wireless circuitry 110 and the eUICC 108, can be configured to enable the wireless device 102 to communicate with an MNO 114 and provide useful features (e.g., phone calls and internet access) to a user of the wireless device 102.

As also shown in FIG. 2, the baseband wireless circuitry 110 of the wireless device 102 can include a baseband OS 214 that is configured to manage hardware resources of the baseband wireless circuitry 110 (e.g., a processor, a memory, different radio components, etc.). According to some embodiments, the baseband wireless circuitry 110 can implement a baseband manager 216 that is configured to interface with the eUICC 108 to establish a secure channel with an MNO provisioning server 116 and obtaining information (such as eSIM/iSIM data) from the MNO provisioning server 116 for purposes of managing eSIMs 208 and/or iSIMs. The baseband manager 216 can be configured to implement services 218, which represents a collection of software modules that are instantiated by way of the various applets 212 of enabled eSIMs 208 that are included in the eUICC 108 and/or iSIMs in the wireless device 102. For example, services 218 can be configured to manage different connections between the wireless device 102 and MNOs 114 according to the different eSIMs 208 that are enabled within the eUICC 108 (and/or different iSIMs enabled in hardware of the wireless device 102). A cellular services switching (CSS) application can reside as an application 204 in the main memory 106 of the wireless device 102 and/or as a service 218 in the baseband wireless circuitry 110. The CSS application can provide for storing cellular wireless access credential, e.g., SIM/eSIM/iSIM, information for access to cellular wireless services and for enabling access to cellular wireless service of an MNO 114, by changing a status of a cellular wireless access credential, e.g., SIM/eSIM/iSIM, to an active state, and for disabling access to cellular wireless service of an MNO 114, e.g., by changing the status of the cellular wireless access credential, e.g., SIM/eSIM/iSIM, to an inactive state. The CSS application can also assist with obtaining and installing a cellular wireless access credential, e.g., an eSIM 208 or iSIM, to gain access to services of an MNO 114. The CSS application can further assist with managing the status of a cellular wireless access credential, e.g., a SIM, an eSIM 208 or an iSIM, which is associated with a common cellular wireless service subscription that may also be used by other wireless devices 102. The CSS application can provide for switching access to cellular wireless services for a cellular wireless service subscription between different wireless devices in a set of wireless devices that are associated with a common cellular wireless service subscription. For one or more iSIMs embedded directly in hardware of the wireless device 102, e.g., in a processor 104, memory 106, or an SoC (not shown), the one or more iSIMs can contain modules that provide similar functionality as those illustrated for eSIMs 208, and supporting eSIM software/firmware, such as the eSIM manager 210 and eUICC OS 206, can be provided by similar software/firmware elements in the hardware of the wireless device 102 in which the one or more iSIMs are stored.

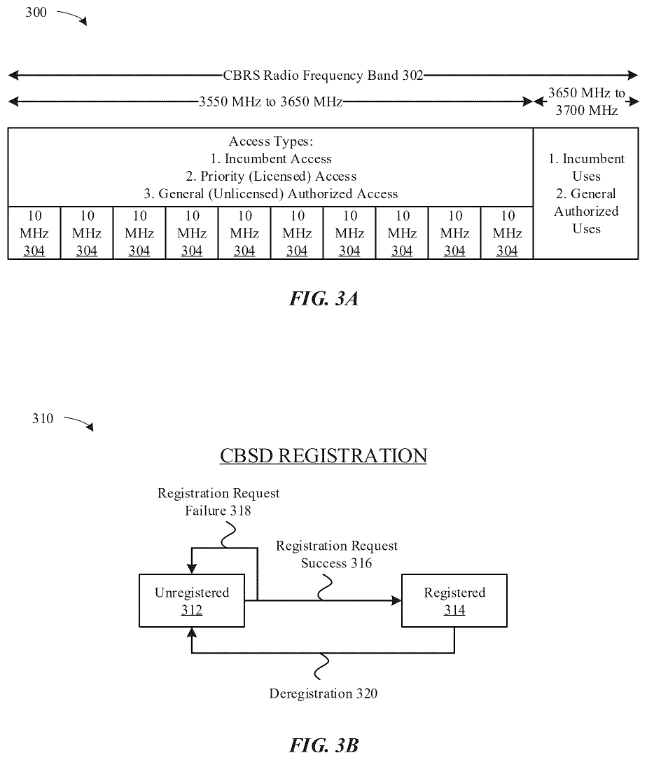

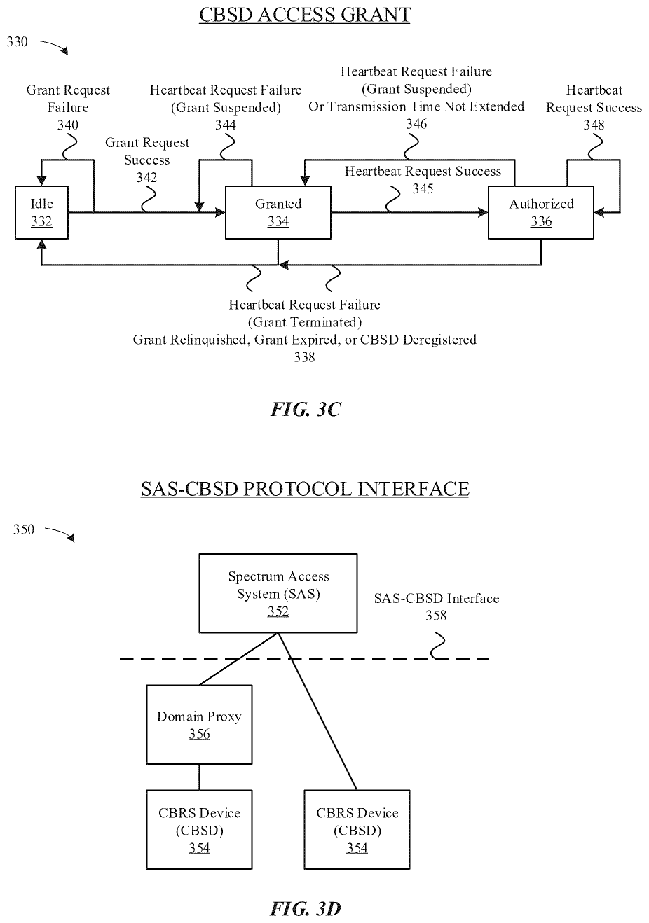

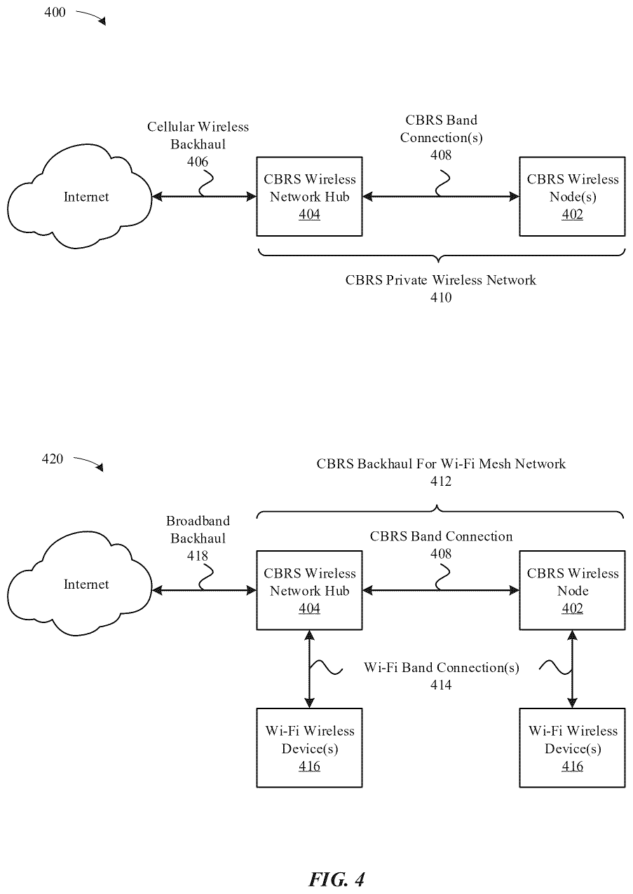

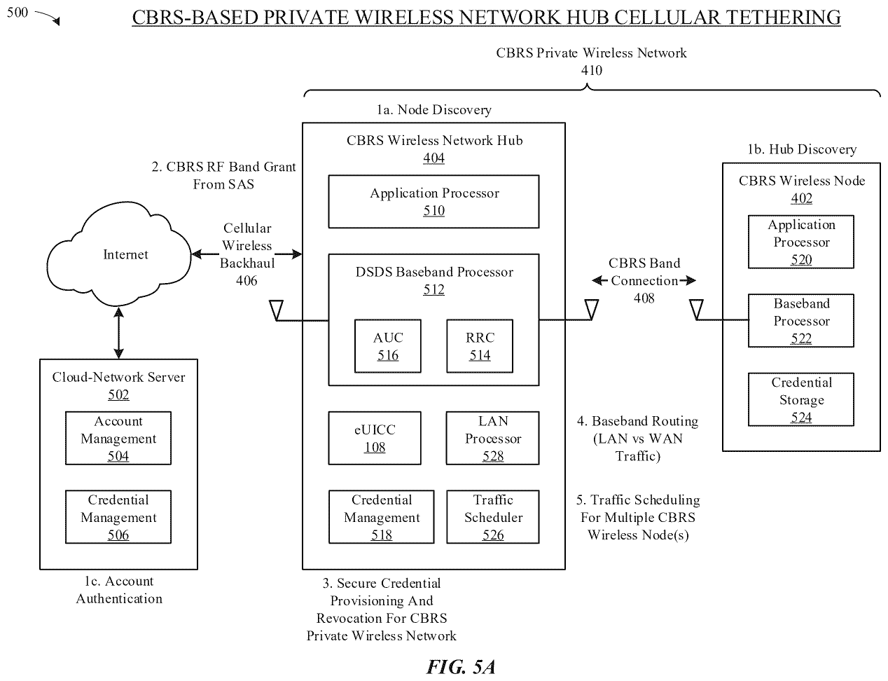

FIG. 3A illustrates an overview diagram 300 of the Citizens Broadband Radio Service (CBRS) radio frequency (RF) spectrum. The Federal Communications Commission (FCC) has allocated the range of radio frequencies from 3550 MHz to 3700 MHz for CBRS to be shared among different types of users. The CBRS RF band 302 includes a first frequency range from 3550 MHz to 3650 MHz that is available i) to incumbent access users, e.g., satellite communications, military uses, ii) to prioritized access users, that license one or more 10 MHz wide channels 304, and iii) to general authorized users with open access with limited interference to the incumbent access users and prioritized access users. The CBRS RF band 302 further includes a second frequency range from 3650 MHz to 3700 MHz that is designated for incumbent uses and for general authorized uses, but is not divided into individual licensable 10 MHz channels 304 as with the first frequency range. The Wireless Innovation Forum (WINNF) published a framework for private fifth generation (5G) cellular wireless networks to use the CBRS band as tier 2 (priority, licensed access) users or as tier 3 (general, unlicensed, authorized access) users in a collaborative manner to reduce interference between users in different areas. A wireless device, e.g., an access point of a private wireless network, can function as a CBRS device (CBSD) by registering for access to and obtaining a grant for use of RF spectrum in the CBRS RF band 302.

FIG. 3B illustrates a state diagram 310 of registration states for a CBSD. The CBSD can be in an unregistered state 312 and can send, to a spectrum access system (SAS) that authorizes and manages use of the CBRS RF spectrum available to CBSDs, a request to register for access to use the CBRS RF band 302. In some cases, the registration request includes an indication that the CBSD is to use general, unlicensed authorized access of the CBRS RF band 302. In response to a successful request to register, the registration state of the CBSD can change from the unregistered state 312 to the registered state 314, as indicated by the registration request success 316 state transition. In some cases, the SAS can send to the CBSD a message indicating the successful registration of the CBSD to access the CBRS RF band 302. In response to an unsuccessful request, e.g., no response, timed out response, negative response, or the like, the CBSD can remain in the unregistered state 312, as indicated by the registration request failure 318 state transition. The registration state of the CBSD can also change from the registered state 314 to the unregistered state 312, as indicated by the deregistration 320 state transition, e.g., response to a request to deregister or based on a message from the SAS.

FIG. 3C illustrates a state diagram 330 of access states of a CBSD that has registered for access to use the CBRS RF band 302. Initially after registration, the CBSD can be in an idle state 332, and is allowed to request a grant to use the CBRS RF band 302. The CBSD can send, to the SAS that manages the CBRS RF spectrum, a request for a grant to use a range of frequencies of the CBRS RF band 302. In response to a successful request for a grant from the SAS, the grant state of the CBSD can change from the idle state 332 to the granted state 334, as indicated by the grant request success 342 state transition. In response to an unsuccessful request for a grant from the SAS, the grant state of the CBSD can remain in the idle state 332, as indicated by the grant request failure 340 state transition. While in the granted stated 334, the CBSD can request for authorization to communicate within the granted frequency range of the CBRS RF band 302 for a period of time by sending to the SAS a heartbeat request message. In response to a successful heartbeat request, the CBSD can transition from the granted state 334 to the authorized state 336, as indicated by the heartbeat request success 345 state transition. While in the authorized state 336, the CBSD can actively communicate via the granted frequency range of the CBRS RF band 302 with other wireless devices. The CBSD can be required to retain the grant for use of the CBRS RF band 302 by sending periodically to the SAS a heartbeat request message. The SAS can determine whether to allow the CBSD to continue to have an active grant for use of the CBRS RF band 302. The CBSD can remain in the authorized state 336 when allowed by the SAS, as indicated by the heartbeat request success 348 state transition. The SAS manages access to the CBRS RF band 302, and higher priority users, such as incumbent users or licensed users with priority access can supersede access by a general access authorized CBSD. In some cases, the SAS can suspend a grant for the CBSD, indicated by the heartbeat request failure 344 state transition when in the granted stated, or as indicated by the heartbeat request failure 346 state transition from the authorized state 336 back to the granted state 334. In some cases, the SAS can determine to limit the transmission time (or not extend the transmission time) for the CBSD and cause the CBSD to transmission from the authorized state 336 (in which transmission is allowed) to the granted state 334 (in which transmission is not allowed but a frequency range in the CBRS RF band 302 is still available for later use by the CBSD). The CBSD can remain in the granted state 334 but unable to obtain authorized access until receiving a successful response to a heartbeat request. In some cases, the SAS can terminate a grant to the CBSD, indicated by the heartbeat request failure 338 state transition and return the CBSD from either the granted state 334 or the authorized state 336 to the idle state 332. Reasons for terminating a grant by the SAS can include expiration of a grant (e.g., heartbeat message not received after a period of time), relinquishment of the grant by the CBSD, or deregistration of the CBSD.

FIG. 3D illustrates a diagram 350 of an SAS-CBSD interface 358 for communication between an SAS 352 and a CBSD 354. In some cases, the SAS 352 communicates with the CBSD 354 directly, while in other cases, the SAS 352 communicates with the CBSD 354 via a domain proxy 356. Registration request (and response), grant requests (and responses), and heartbeat requests (and responses) can be communicated via the SAS-CBSD interface 358 between the SAS 352 and the CBSD 354 directly or indirectly through the domain proxy 356. The domain proxy 356 can aggregate communication for multiple CBSDs 354 with an SAS 352.

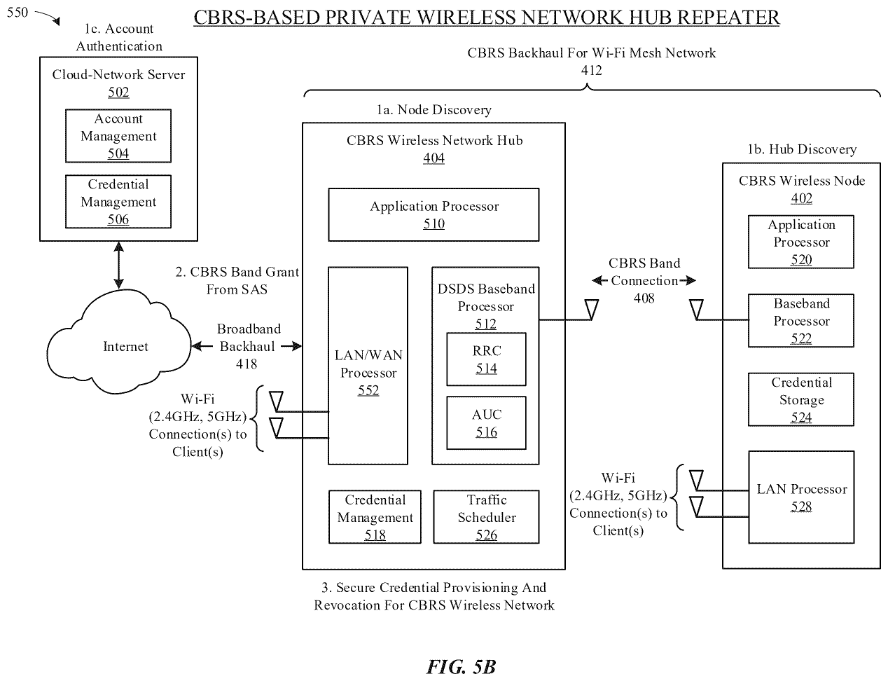

FIG. 4 illustrates diagrams 400, 420 of two exemplary scenarios to use the CBRS RF band 302 for communication between a CBRS wireless network hub 404 and one or more CBRS wireless nodes 402. In the first scenario illustrated in diagram 400, the CBRS wireless network hub 404 can use a CBRS RF band to form a CBRS private wireless network 410 with one or more CBRS band connections 408 to one or more CBRS wireless nodes 402. Communication in the CBRS private wireless network 410 can be used to supplement or to replace communication in one or more WLAN RF bands, such as the 2.4 GHz and/or 5 GHz Wi-Fi bands that may be congested due to multiple users and can incur interference due to their open access nature. In some cases, the CBRS private wireless network 410 is used as an alternative connection for devices that would otherwise operate using the 2.4 GHz and/or 5 GHz bands. The CBRS wireless network hub 404 can connect to the Internet via a cellular wireless backhaul 406 connection. The CBRS private wireless network 410 can provide interference-free (or reduced interference) tethering for CBRS wireless nodes 402 that may not have direct cellular wireless access. In some cases, the backhaul connection can be via an alternative (non-cellular) connection, such as a broadband backhaul connection 418 (not otherwise shown in the diagram 400). As discussed further herein, an eSIM 208 can be provisioned to a CBRS wireless node 402 to allow the CBRS wireless node 402 to communicate with the CBRS wireless network hub 404. In some cases, the eSIM 208 uses a public certificate issuer (CI) that chains up to a particular entity, e.g., a device manufacturer, and does not require typical cellular wireless certification by a cellular wireless standards body, such as the Global System for Mobile Communications (GSM) Association (GSMA).

In the second scenario illustrated in diagram 420, the CBRS wireless network hub 404 establishes a CBRS band connection 408 to a CBRS wireless node 402 as an alternative internal CBRS backhaul for a WLAN, e.g., Wi-Fi, mesh network. Some existing Wi-Fi mesh routers use the shared 2.4 GHz and/or 5.0 GHz Wi-Fi bands for a backhaul connection, where the 2.4 GHz and/or 5.0 GHz Wi-Fi bands are also shared for communication with other Wi-Fi wireless devices 416. Using the CBRS band connection 408 between the CBRS wireless network hub 404 and the CBRS wireless node 402 to form a CBRS backhaul connection in a different RF band, allows for efficient, interference-free (or reduced interference) communication while reducing interference in the 2.4 GHz and/or 5.0 GHz Wi-Fi bands used for communication with the Wi-Fi wireless devices 416. The CBRS wireless network hub 404 and/or the CBRS wireless node 402 can provide separate Wi-Fi band connections 414 to one or more Wi-Fi wireless devices 416. Some existing Wi-Fi mesh networks use a 6 GHz band for a backhaul connection; however, the 3.5 GHz band can provide an extended range of operation compared to the 6 GHz band for the backhaul connection.

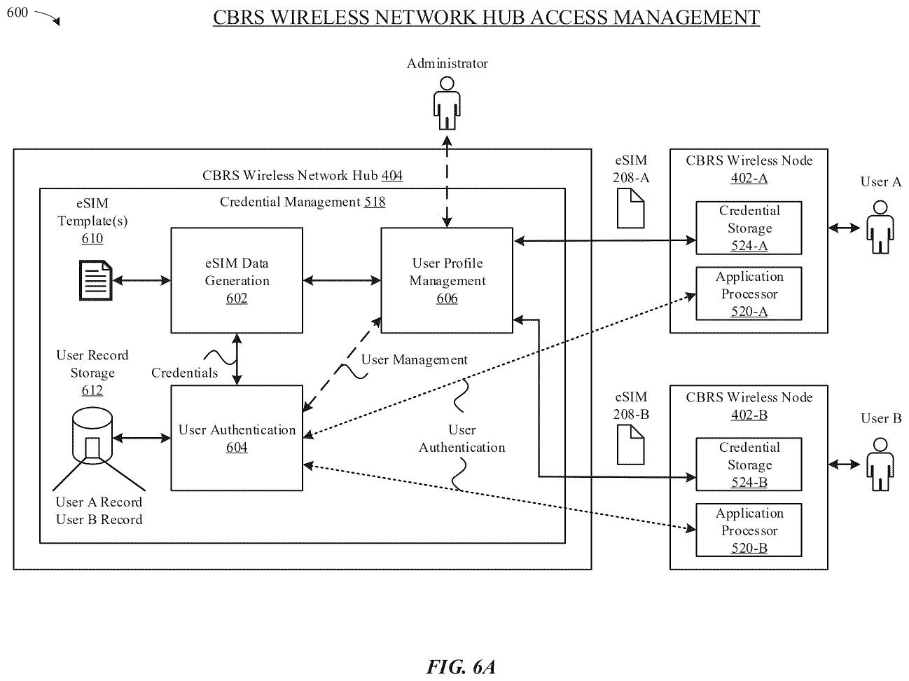

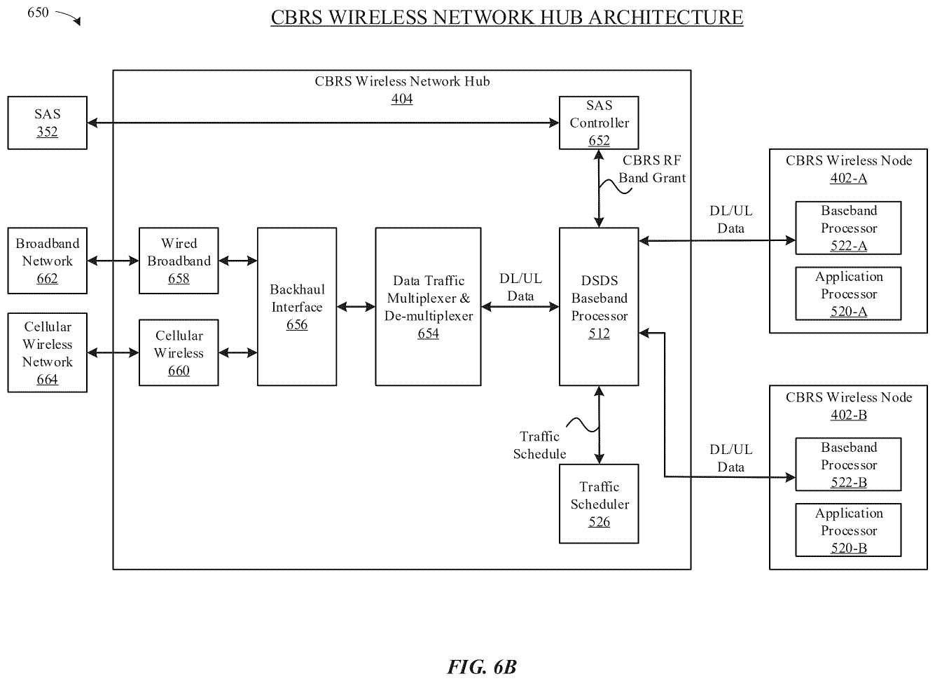

FIG. 5A illustrates a diagram 500 of an example of using a CBRS private wireless network 410 for cellular tethering a CBRS wireless node 402 via a CBRS wireless network hub 404. The CBRS wireless network hub 404 can include hardware that supports a dual SIM, dual standby (DSDS) capability, e.g., to allows for multiple cellular subscriptions to be available for use by the CBRS wireless network hub 404. In a DSDS wireless device, two eSIMs 208 can be installed in the eUICC 108; however, only one eSIM 208 can be actively communicating at a time due to hardware limitations. (In contrast, a dual SIM, dual active (DSDA) wireless device is capable of simultaneous communication with two different SIMs via distinct hardware.) In some cases, the DSDS wireless device, such as the CBRS wireless network hub 404 illustrated in diagram 500, can include hardware that supports communication with a cellular wireless network and communication via a CBRS private wireless network 410 at the same time. The CBRS wireless network hub 404 can include a cellular wireless backhaul 406 connection via a cellular wireless network (including a data connection capability to the Internet) to access network-based services. The CBRS wireless network hub 404 can include a DSDS baseband processor 512 that is configurable with multiple (at least two) distinct software stacks that each support a different wireless communication protocol for a distinct SIM or eSIM 208. As multiple software protocol stacks are available, one software protocol stack can be used for cellular wireless communication with a cellular wireless network via the cellular wireless backhaul 406, and another software protocol stack can be used for CBRS communication via one or more CBRS band connections 408 to one or more CBRS wireless nodes 402. The DSDS baseband processor 512 includes various modules for managing cellular wireless communication, such as a radio resource control (RRC) module 514 for signaling control messages and an AUC module 516 that authenticates users and authorizes access to features of the CBRS wireless network hub 404. The CBRS wireless network hub 404 further includes an application processor 510 for execution of higher layer applications that may seek to access communication services provided through the DSDS baseband processor 512. The CBRS wireless network hub 404 also includes a LAN processor 528 and traffic scheduler module 526 that can be used for managing data traffic of the CBRS wireless network hub 404. The CBRS wireless network hub 404 further includes a credential management module 518 that can support generation and/or acquisition of an eSIM 208 to install in the eUICC 108 and/or to provide to the CBRS wireless node 402 to provide the capabilities and protocols for the CBRS private wireless network 410. A CBRS wireless node 402 similarly includes an application processor 520, a baseband processor 522, and a credential storage module 524. Both the CBRS wireless network hub 404 and the CBRS wireless node 402 include hardware to support a CBRS band connection 408 in the CBRS RF band 302.

The CBRS wireless network hub 404 can be configured to manage a CBRS private wireless network 410, including supporting addition and deletion of a CBRS wireless node 402 to the CBRS private wireless network. The CBRS wireless network hub 404 can be associated with an online cloud-network service account, e.g., an iCloud® account, that provides various services to manage and associate a set of computing devices together. The CBRS wireless network hub 404 can communicate via an Internet data connection with a cloud-network server 502 of the online cloud-network service. The cloud-network server 502 can maintain (or have access to) a record of computing devices associated with a particular online cloud-network service account and can manage features of communication services and other types of services via an account management module 504. In some cases, the cloud-network server 502 can generate and/or manage credentials that are included in cellular profiles, e.g., eSIMs 208, which can be used for allowing a computing device, e.g., the CBRS wireless node 402, to connect to the CBRS private wireless network 410 via the CBRS band connection 408. The cloud-network server 502 can include a credential management module 506 that generates and/or stores credentials on behalf of the CBRS wireless network hub 404 for one or more CBRS wireless nodes 402 that will attach to the CBRS private wireless network 410 via CBRS band connections 408.

To form and/or manage the CBRS private wireless network 410, the CBRS wireless network hub 404 and the CBRS wireless node 402 can initially perform a discovery procedure by which the CBRS wireless network hub 404 and the CBRS wireless node 402 determine the presence of the other device. In some cases, the CBRS wireless network hub 404 and the CBRS private wireless network 410 use a wireless personal area network (WPAN) procedure, e.g., a Bluetooth procedure, or a wireless local area network (WLAN) procedure, e.g., a Wi-Fi procedure, to identify each other. The CBRS wireless network hub 404 can obtain information from the CBRS wireless node 402 including identification of an online cloud-network service account used by the CBRS wireless node 402. The CBRS wireless network hub 404 can communicate with the cloud-network server 502 to determine whether i) the CBRS wireless node 402 and the CBRS wireless network hub 404 share a common online cloud-network service account of the cloud-network service provided by the cloud-network server 502, ii) the CBRS wireless node 402 and the CBRS wireless network hub 404 have different online cloud-network service accounts with the same cloud-network service provided by the cloud-network server 502, or iii) the CBRS wireless node 402 does not have a cloud-network service account with the cloud-network service provided by the cloud-network server 502. In some embodiments, the CBRS wireless network hub 404 performs account authentication with the cloud-network server 502 to determine whether to allow the CBRS wireless node to join the CBRS private wireless network 410.

The CBRS wireless network hub 404 also communicates with a network-based spectrum access system (SAS) 352 to obtain a grant to use a range of radio frequencies in the CBRS RF band 302. To add the CBRS wireless node 402 to the CBRS private wireless network 410, the CBRS wireless network hub 404 can provide to the CBRS wireless node 402 an eSIM 208 that includes credentials to allow the CBRS wireless node to authenticate with and use the CBRS private wireless network 410. In some embodiments, a credential management module 518 of the CBRS wireless network hub 404 generates the eSIM 208 and provisions the eSIM 208 to the CBRS wireless node 402. In some cases, the CBRS wireless network hub 404 obtains the eSIM 208 from the cloud-network server 502, which can generate the eSIM 208 using its own credential management module 506. In some embodiments, one or both of the cloud-network server 502 and the CBRS wireless network hub 404 can generate an eSIM 208 specific to a CBRS wireless node 402 for a specific CBRS private wireless network 410 managed by the CBRS wireless network hub 404. The CBRS wireless network hub 404 can also revoke use of an eSIM 208 provided to a CBRS wireless node 402 to access the CBRS private wireless network 410. In some embodiments, an eSIM 208 provided to a CBRS private wireless network 410 can be revoked by the CBRS wireless network hub 404 and stored, e.g., at the CBRS wireless network hub 404 or at the cloud-network server 502, for later re-provisioning and re-use by the CBRS wireless node 402.

The CBRS wireless network hub 404 includes both the DSDS baseband processor and a LAN processor module 528 that can each manage routing of data packets of the CBRS wireless network hub 404. In some cases, the DSDS baseband processor 512 can provide baseband level packet management to differentiate data traffic that is local to the CBRS wireless network hub 404, e.g., LAN packets to be routed locally between the CBRS wireless node 402 and another device connected via a WLAN to the CBRS wireless network hub 404 (or to be consumed locally at the CBRS wireless node 402), and data traffic to be sent outside the CBRS private wireless network, e.g., WAN packets from the CBRS wireless node 402 to be routed remotely through the CBRS wireless node 402 to an Internet node via the cellular wireless backhaul 406. The LAN processor 528 can also provide management of WPAN(s) and/or WLAN(s) maintained by the CBRS wireless network hub 404 using WPAN (e.g., Bluetooth) and/or WLAN (e.g., Wi-Fi) communication protocols. The CBRS wireless network hub 404 further includes a traffic scheduler module 526 that can manage traffic scheduling for communication between the CBRS wireless network hub 404 and one or more CBRS wireless nodes 402. Communication of data traffic on the CBRS private wireless network 410 can be scheduled, in some cases, to reduce interference of communication for multiple CBRS wireless nodes 402 connected to the CBRS wireless network hub via the CBRS band connections 408 of the CBRS private wireless network 410.

FIG. 5B illustrates a diagram 550 of an example of using a CBRS wireless network hub 404 to provide a CBRS backhaul connection 412 for a Wi-Fi mesh network. In the example illustrated in FIG. 5B, the CBRS wireless network hub 404 connects with a CBRS wireless node 402 via a CBRS band connection 408 to provide a high packet data transport between the CBRS wireless node 402 and the CBRS wireless network hub 404. By using radio frequencies in the CBRS RF band 302, the CBRS band connection 408 can provide a backhaul with reduced interference for data traffic from various wireless client devices (not shown) that have WLAN connections, e.g., Wi-Fi connections in the 2.4 GHz and/or 5.0 GHz bands, with the CBRS wireless node 402, as the CBRS RF band 302 is separate from the Wi-Fi bands. In addition a backhaul connection using the CBRS RF band 302 can extend for greater distances and penetrate obstacles more readily than a backhaul connection that uses a higher RF band, such as a 6.0 GHz band. The CBRS wireless network hub 404 can perform a node discovery procedure, while the CBRS wireless node 402 can perform a hub discovery procedure. In some cases, the CBRS wireless network hub 404 and the CBRS private wireless network 410 use a WPAN procedure, e.g., a Bluetooth procedure, or a WLAN procedure, e.g., a Wi-Fi procedure, to identify each other. The CBRS wireless network hub 404 can use information obtained from the CBRS wireless node 402 for authentication, e.g., of an online cloud-network service account, via a cloud-network server 502 that provides the online cloud-network service. The CBRS wireless network hub 404 can obtain a grant to use radio frequencies in the CBRS band from an SAS 352. The CBRS wireless network hub 404 can also perform secure provisioning of an eSIM 208 to the CBRS wireless node 402 to use for connecting via the CBRS RF band 302 with the CBRS wireless network hub 404. In some cases, the CBRS wireless network hub 404 generates the eSIM 208, while in some cases, the cloud-network server 502 generates the eSIM 208. The CBRS wireless network hub 404 can also manage use of the eSIM 208 of the CBRS wireless node 402, revoke access for the CBRS wireless node 402, and in some cases store an eSIM 208 locally at the CBRS wireless network hub 404 or remotely at the cloud-network server 502 (e.g., for backup purposes and/or to permit re-use). The CBRS wireless network hub 404 further includes a LAN/WAN processor 552 (or multiple such processors) that can provide a broadband backhaul 418 remote connection to the Internet for remote data traffic via a WAN and that also can provide local Wi-Fi connections to clients for local data traffic via a WLAN, such as a Wi-Fi network.

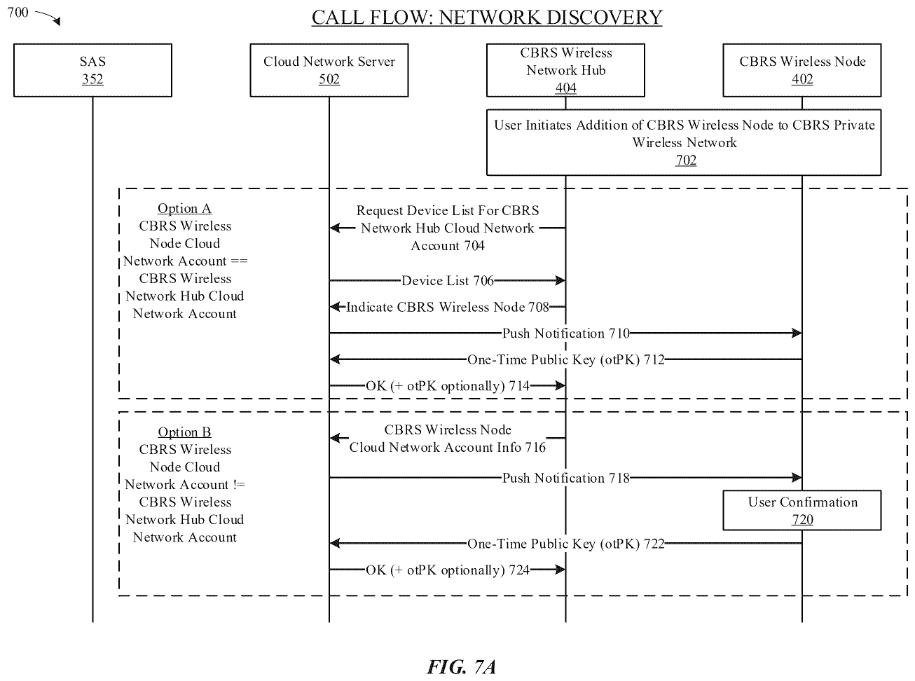

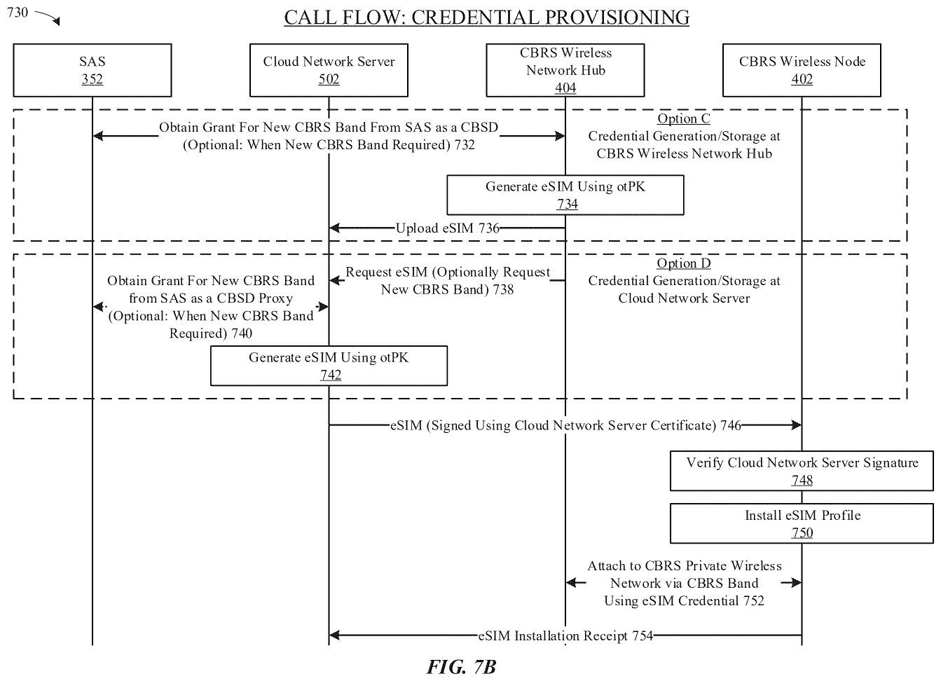

FIG. 6A illustrates a diagram 600 of an example of a CBRS wireless network hub 404 managing access to a CBRS private wireless network 410. The CBRS wireless network hub 404 includes a credential management module 518 that generates an eSIM 208-A for a first CBRS wireless node 402-A associated with user A and an eSIM 208-B for a second CBRS wireless node 402-B associated with user B. The CBRS wireless network hub 404 can generate an eSIM 208 for a CBRS wireless nodes 402 during an initial connection procedure between the CBRS wireless network hub 404 and the CBRS wireless node 402. The eSIM 208 can be generated in accordance with GSMA standardized procedures. The eSIM 208 can be generated in real time by the CBRS wireless network hub 404 and provided to the CBRS wireless node 402 via an over-the-air (OTA) procedure, e.g., via a Bluetooth, Wi-Fi, or peer-to-peer connection. The credential management module 518 includes an eSIM data generation module 602 that generates eSIMs 208 including credentials, a file system, application, and the like. Credentials for eSIMs 208 can be shared by the eSIM data generation module 602 with a user authentication module 604 that is connected to a user record storage module 612 that can maintain user records for users associated CBRS wireless nodes 402 that connect to the CBRS wireless network hub 404. The user authentication module 604 can authenticate a user of a CBRS wireless node 402, using information provided by the CBRS wireless node 402, and can authorize the CBRS wireless node 402 to access CBRS wireless network features provided by the CBRS wireless network hub 404. The credential management module 518 of the CBRS wireless network hub 404 can further include a user profile management module 606, which can be overseen by an administrator, and can process requests from users, e.g., user A of CBRS wireless node 402-A and user B of CBRS wireless node 402-B, that seek to gain access to the CBRS private wireless network 410 managed by the CBRS wireless network hub 404. The user profile management module 606 can include a separate root function for provisioning eSIMs 208 to the CBRS wireless nodes 402. The user authentication module 604 can communicate with an application processor 520-A of CBRS wireless node 402-A and/or with an application processor 520-B of CBRS wireless node 402-B to authenticate users of the respective CBRS wireless nodes 402. In some cases, the user authentication module 604 accesses user records in the user record storage module 612 (which in some cases may be remote from the CBRS wireless network hub 404) and can use information in user records to authenticate the user of the CBRS wireless node 402. In some cases, the user authentication module 604 provides information about the user and/or bout the CBRS wireless node to the eSIM data generation module 602 to allow the eSIM data generation module 602 to customize the eSIM 208 generated for the CBRS wireless node 402, e.g., by adding user and/or device specific information to an eSIM template 610. The user profile management module 606 can provide the eSIM 208-A generated for the CBRS wireless node 402-A via a wireless connection, e.g., Bluetooth, Wi-Fi, peer-to-peer WLAN, etc., and similarly provide the eSIM 208-B generated for the CBRS wireless node 402-B via a wireless connection.

FIG. 6B illustrates a diagram 650 of an exemplary architecture of a CBRS wireless network hub 404. The CBRS wireless network hub 404 includes a wired broadband module 658 that can communicate with one or more devices to access a broadband network 662, e.g., through a digital subscriber line (DSL) broadband service, a cable modem broadband service, a fiber broadband service, and the like. The CBRS wireless network hub 404 can also include a cellular wireless module 660 that enables the CBRS wireless network hub 404 to connect to a cellular wireless network 664. The CBRS wireless network hub 404 can use one or more both of the interfaces (wired broadband or cellular wireless) for communicating data packets. The wired broadband module 658 and the cellular wireless module 660 can connect to a backhaul interface 656 that transports wide area network (WAN) data traffic for the CBRS wireless network hub 404 received from a data traffic multiplexer and de-multiplexer module 654. Uplink (UL) data from the CBRS wireless network hub 404 (and which can have originated at the CBRS wireless nodes 402-A, 402-B) is passed from a dual-SIM, dual-standby (DSDS) baseband processor 512 to the data traffic multiplexer and de-multiplexer that groups UL data packets for transport via the wired backhaul (to the broadband network 662) and/or via the wireless backhaul (to the cellular wireless network 664). Similarly, downlink (DL) data packets received via the backhaul interfaces are communicated to the DSDS baseband processor 512 for communication to baseband processors 522-A, 522-B of the CBRS wireless nodes 402-A, 402-B. A traffic scheduler module 526 can determine a traffic schedule for when and how data can be communicated between the CBRS wireless network hub 404 and the CBRS wireless nodes 402-A, 402-B. The CBRS wireless network hub 404 further includes a SAS controller module 652 that communicates with the network-based SAS 352 to obtain a CBRS RF band grant to allow the CBRS wireless network hub 404 to use a portion of radio frequencies in the CBRS RF band 302.

A broad variety of wireless device 102 that include a dual connectivity capability (i.e., able to communicate in distinct radio frequency bands at the same time) can be configured to operate as a CBRS wireless network hub 404. A wireless device 102 that supports DSDS or DSDA communication via two different baseband radio frequencies, one radio frequency band used for the cellular wireless backhaul 406 connection and one radio frequency band used for the CBRS band connection 408, can be configured to operate as a CBRS wireless network hub 404. A Wi-Fi router with a baseband radio that can operate in the CBRS RF band 302 can provide Wi-Fi connections for client devices and a backhaul connection via the CBRS RF band 302, e.g., as a CBRS wireless node 402. In some embodiments, a CBRS wireless node 402 stores an eSIM 208 for access to a CBRS private wireless network 410 (or to establish and maintain a CBRS backhaul connection) in a secure element, e.g., an eUICC 108 or an embedded secure enclave (eSE) separate from (or in place of) an eUICC 108. The secure element of the CBRS wireless node 402 can store a digital certificate (for authentication and verification purposes), where the digital certificate chains up to a root certificate issuer (CI) associated with a device manufacturer of the CBRS wireless node 402. In some embodiments, a CBRS wireless node 402 can request (obtain), activate, or deactivate an eSIM 208 for access to a CBRS private wireless network 410 (or to have a capability to connect to a CBRS wireless network hub 404) based on a geo-location of the CBRS wireless node 402. In some cases, the eSIM 208 can be deleted from the CBRS wireless node 402 responsive to a user deletion request. In some embodiments, generation and management of eSIMs 208 for access to a CBRS private wireless network 410 occurs in the CBRS wireless network hub 404 and/or in a cloud-network server 502. In some embodiments, a cloud-network server 502 can serve as a domain proxy 356 to manage admission control and interference between multiple CBRS wireless network hubs 404 that each seek to maintain their own CBRS private wireless networks 410 and/or CBRS wireless backhaul connections. A CBRS wireless node 402 can be required to authenticate with a CBRS wireless network hub 404 in order to obtain access to use a CBRS band connection 408. In some embodiments, after an eSIM 208 has been deployed to a CBRS wireless node 402, authentication of the CBRS wireless node 402 can be based on authentication procedures as used for 3GPP wireless eSIMs 208, e.g., using a shared secret known to the CBRS wireless network hub 404 and the CBRS wireless node 402. In some embodiments, authentication of the CBRS wireless node 402 can be based on an EAP TLS procedure using digital signal signatures to verify identifies of the CBRS wireless network hub 404 and the CBRS wireless node 402.

A CBRS wireless network hub 404 can include a scheduling functionality to manage radio resources of the CBRS private wireless network among multiple CBRS wireless nodes 402. The CBRS wireless network hub 404 can be configured to maintain system information for the CBRS private wireless network 410, and in some cases provide paging information and connection establishment control signals to CBRS wireless nodes 402.

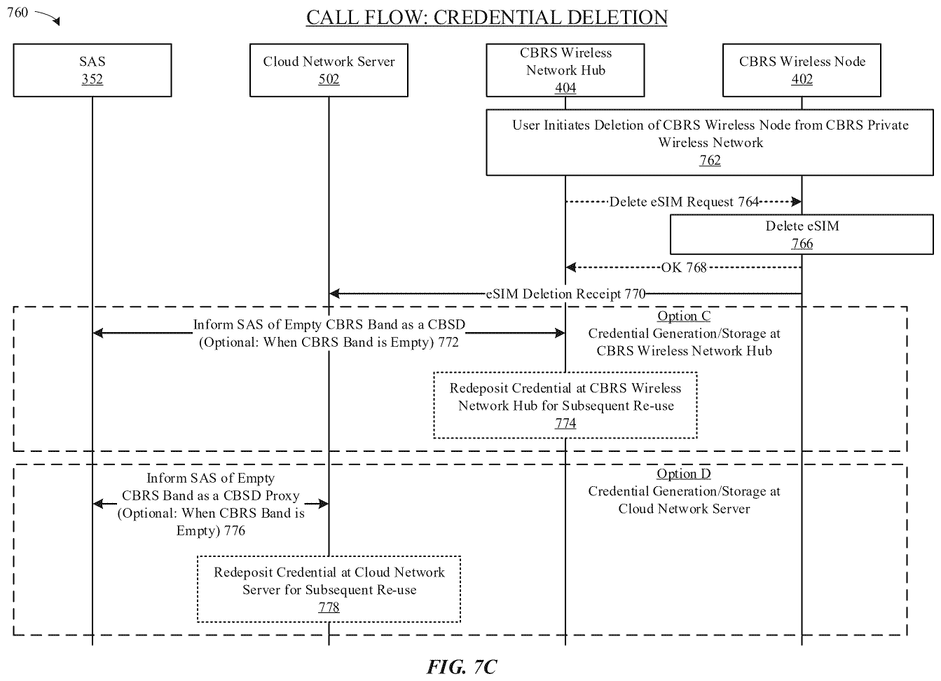

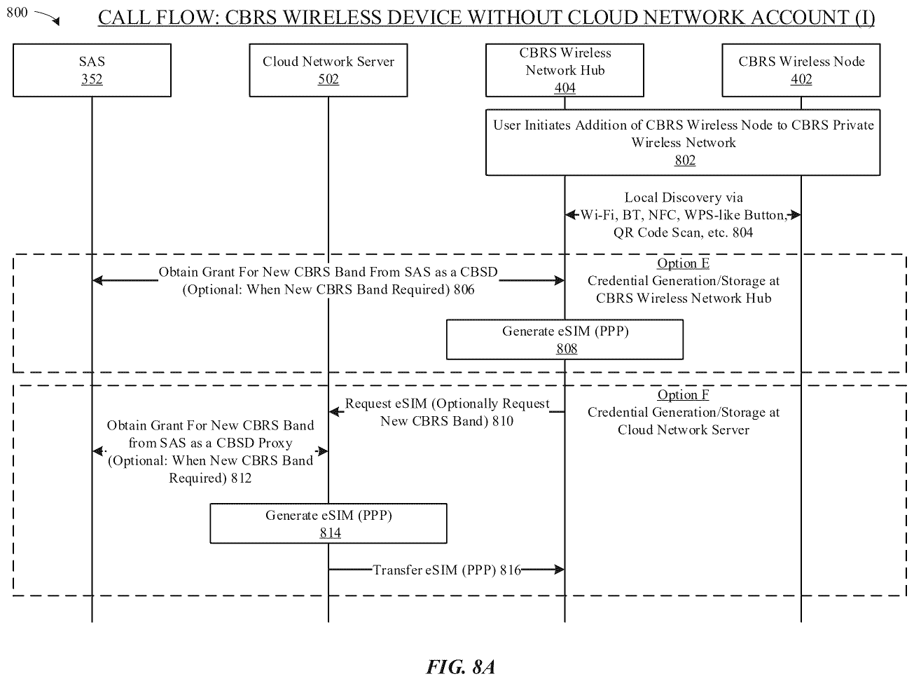

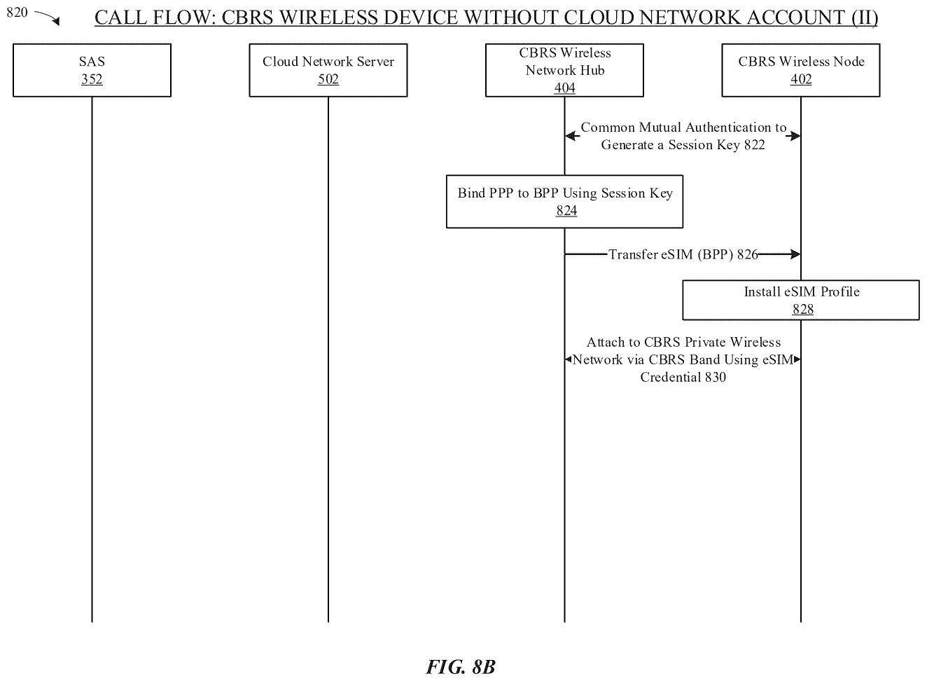

FIG. 7A illustrates a flow diagram 700 of an example of a network discovery stage in a call flow for adding a CBRS wireless node 402 to a CBRS private wireless network 410. At 702, a user of the CBRS wireless node 402 initiates a procedure to add the CBRS wireless node 402 to the CBRS private wireless network 410 managed by the CBRS wireless network hub 404. The user can initiate addition of the CBRS wireless node 402 by interacting directly with the CBRS wireless network hub 404 or indirectly with the CBRS wireless network hub 404 via the CBRS wireless node 402. The CBRS wireless network hub 404 obtains information regarding an online cloud-network service account of the CBRS wireless node 402 and proceeds to either option A or option B based on whether the CBRS wireless network hub 404 and the CBRS wireless node 402 share a common online cloud-network service account. When the online cloud-network service account of the CBRS wireless node 402 is the same as the online cloud-network service account of the CBRS wireless network hub 404, the process of FIG. 7A continues with option A. When the CBRS wireless network hub 404 and the CBRS wireless node 402 do not share a common online cloud-network service account, the process of FIG. 7A continues with option B.

For option A, at 704, the CBRS wireless network hub 404 sends a message to the cloud-network server 502 to obtain a list of wireless devices 102 associated with an online cloud-network service account of the CBRS wireless network hub 404. At 706, the cloud-network server 502 responds with the list of wireless devices 102 associated with the online cloud-network service account of the CBRS wireless network hub 404. When the CBRS wireless node 402 is confirmed to be included in the list of wireless devices 102 associated with the online cloud-network service account of the CBRS wireless network hub 404, at 708, the CBRS wireless network hub 404 provides to the cloud-network server 502 an indication that the CBRS wireless node 402 seeks to join a CBRS private wireless network 410 managed by the CBRS wireless network hub 404. At 710, the cloud-network server 502 sends to the CBRS wireless node 402, directly via a separate communication path, or indirectly via the CBRS wireless network hub 404, a push notification message 710 to prompt the CBRS wireless node 402 for a one-time public key (otPK) to be used for generating an eSIM 208 to provide to the CBRS wireless node 402 to access the CBRS private wireless network 410. At 712, the CBRS wireless node 402 responds to the cloud-network server, again directly or indirectly, with a message that includes the otPK. At 714, the cloud-network server 502, sends and affirmative OK message to the CBRS wireless network hub 404 indicating approval for addition of the CBRS wireless node 402 to the CBRS private wireless network 410 managed by the CBRS wireless network hub 404. In some embodiments, the affirmative OK message from the cloud-network server 502 includes the otPK received by the cloud-network server 502 from the CBRS wireless node 402.

For option B, at 716, the CBRS wireless network hub 404 provides to the cloud-network server 502 an indication of the online cloud-service account of the CBRS wireless node 402, which is different from the online cloud-service account of the CBRS wireless network hub 404, and an indication that the CBRS wireless node 402 seeks to join a CBRS private wireless network 410 managed by the CBRS wireless network hub 404. At 718, the cloud-network server 502 sends to the CBRS wireless node 402, directly via a separate communication path, or indirectly via the CBRS wireless network hub 404, a push notification message 710 to prompt the CBRS wireless node 402 for a one-time public key (otPK) to be used for generating an eSIM 208 to provide to the CBRS wireless node 402 to access the CBRS private wireless network 410. At 720, the CBRS wireless node 402 obtain confirmation from a user of the CBRS wireless node 402 of the request to join the CBRS private wireless network 410 of the CBRS wireless network hub 404. At 722, the CBRS wireless node 402 responds to the cloud-network server, again directly or indirectly, with a message that includes the otPK. At 724, the cloud-network server 502, sends and affirmative OK message to the CBRS wireless network hub 404 indicating approval for addition of the CBRS wireless node 402 to the CBRS private wireless network 410 managed by the CBRS wireless network hub 404. In some embodiments, the affirmative OK message from the cloud-network server 502 includes the otPK received by the cloud-network server 502 from the CBRS wireless node 402.

FIG. 7B illustrates a flow diagram 730 of an example of a credential provisioning stage in a call flow for adding a wireless node to the CBRS private wireless network 410 managed by the CBRS wireless network hub 404. Two options for generating and provisioning the eSIM 208, which includes the credentials for the CBRS wireless node 402 to access the CBRS private wireless network 410, are shown. In option C, the eSIM 208 is generated at the CBRS wireless network hub 404. In option D, the eSIM 208 is generated at the cloud-network server 502.

For option C, when the CBRS wireless network hub 404 requires a range of radio frequencies in the CBRS RF band 302 to use for the CBRS private wireless network 410, the CBRS wireless network hub 404 communicates with a SAS 352 to obtain a grant for a new (or re-use a previous) CBRS band as a CBSD 354. In some embodiments, the CBRS wireless network hub 404 communicates directly with the SAS 352. In some embodiments, the CBRS wireless network hub communicates indirectly with the SAS 352 via a domain proxy 356. In some embodiments, the cloud-network server 502 can serve as the domain proxy 356 for communication with the SAS 352. At 734, the CBRS wireless network hub 404 generates an eSIM 208 for the CBRS wireless node 402 using the otPK previously provided by the CBRS wireless node 402. At 736, the CBRS wireless network hub 404 uploads to the cloud-network server 502 the eSIM 208.

For option D, the CBRS wireless network hub 404, at 738, sends a message to the cloud-network server 502 requesting that the cloud-network server 502 generate an eSIM 208 for the CBRS wireless node 402 to use to access the CBRS private wireless network 410 managed by the CBRS wireless network hub 404. In some embodiments, the message requesting the eSIM (or a separate message) includes a request to obtain a grant for a new (or re-use a previous) CBRS band for the CBRS wireless network hub 404 to use for the CBRS private wireless network 410, e.g., when the CBRS wireless network hub 404 requires a new (re-use of a previous) CBRS band. At 740, the cloud-network server 502 communicates with the SAS 352 to obtain the CBRS band for the CBRS wireless network hub, when the CBRS wireless network hub 404 requires a new (re-use of a previous) CBRS band. At 742, the cloud-network server 502 generates the eSIM 208 for the CBRS wireless node 402 using the otPK previously provided by the CBRS wireless node 402.

Continuing the procedure, the cloud-network server 502 sends to the CBRS wireless node 402 a message that includes the eSIM 208 (generated by the cloud-network server 502 or generated by the CBRS wireless network hub 404 and provided to the cloud-network server 502). In some embodiments, the cloud-network server 502 communicates with the CBRS wireless node 402 directly. In some embodiments, the cloud-network server 502 communicates with the CBRS wireless node 402 indirectly via the CBRS wireless network hub 404. At 748, the CBRS wireless node 402 verifies a signature of the cloud-network server 502 that accompanies (or is part of) the message that includes the eSIM 208. At 750, after successful verification of the validity of the message from the cloud-network server 502, the CBRS wireless node 402 installs the eSIM 208 in a secure element, e.g., an eUICC 108 or embedded secure enclave (eSE), of the CBRS wireless node 402. At 752, the CBRS wireless node 402 attaches to the CBRS private wireless network 410 using credentials of the eSIM 208. At 754, the CBRS wireless node 402 sends to the cloud-network server 502 (directly or indirectly via the CBRS wireless network hub 404) an indication of receipt and successful installation of the eSIM 208 at the CBRS wireless node 402.

FIG. 7C illustrates a flow diagram 760 of an example of a credential deletion stage of a call flow for removing a CBRS wireless node 402 from a CBRS private wireless network 410. At 762, a user of the CBRS wireless node 402 initiates a procedure to delete the CBRS wireless node 402 from the CBRS private wireless network 410 managed by the CBRS wireless network hub 404. The user can initiate deletion of the CBRS wireless node 402 by interacting directly with the CBRS wireless network hub 404 or indirectly with the CBRS wireless network hub 404 via the CBRS wireless node 402. When the user initiates deletion of the eSIM 208 at the CBRS wireless network hub at 762, 404, then, at 764, the CBRS wireless network hub 404 can send a message to the CBRS wireless node 402 indicating the request to delete the eSIM 208. In some embodiments, an administrator of the CBRS wireless network hub 404 can initiate deletion of the eSIM 208 from the CBRS wireless node 402, e.g., by causing the CBRS wireless network hub 404 to send to the CBRS wireless node 402 the message requesting deletion of the eSIM 208. At 766, the CBRS wireless node 402 executes a procedure to delete the eSIM 208 used to access the CBRS private wireless network 410 from the secure storage, e.g., from the eUICC 108 or the eSE, of the CBRS wireless node 402. At 768, optionally, the CBRS wireless node 402 can send a message to the CBRS wireless network hub 404 (via a communication path other than the CBRS private wireless network 410) indicating successful deletion of the eSIM 208. At 770, the CBRS wireless node 402 can send a message to the cloud-network server 502 indicating that the eSIM 208 that included credentials for access to the CBRS private wireless network 410 managed by the CBRS wireless network hub 404 has been deleted by the CBRS wireless node 402. The procedure for eSIM deletion can proceed via one of two different options, option C or option D, depending on which entity generated the eSIM 208 that was deleted.

For option C, when the deleted eSIM 208 was previously generated by the CBRS wireless network hub 404, the CBRS wireless network hub 404, at 774, can optionally store the deleted eSIM 208 (or credentials included therein) in storage accessible to the CBRS wireless network hub 404, e.g., locally at the CBRS wireless network hub 404 or remotely in remote storage accessible by the CBRS wireless network hub 404, for subsequent reuse by the CBRS wireless node 402. In addition, when the CBRS private wireless network 410 is empty (has no CBRS wireless nodes 402 with extant eSIMs 208 to access the CBRS private wireless network 410), the CBRS wireless network hub, at 772, can optionally inform the SAS 352 of the empty CBRS band granted by the SAS for the CBRS private wireless network 410.

For option D, when the deleted eSIM 208 was previously generated by the cloud-network server 502, the cloud-network server 502, at 778, can optionally store the deleted eSIM 208 (or credentials included therein) in storage accessible to the cloud-network server 502 for subsequent reuse by the CBRS wireless node 402. In addition, when the CBRS private wireless network 410 of the CBRS wireless network hub 404 is empty (has no CBRS wireless nodes 402 with extant eSIMs 208 to access the CBRS private wireless network 410), the cloud-network server, at 776, can optionally inform the SAS 352 of the empty CBRS band granted by the SAS for the CBRS private wireless network 410, where the cloud-network server 502 can operate as a CBSD proxy between the CBRS wireless network hub 404 (which operates as a CBSD) and the SAS 352.

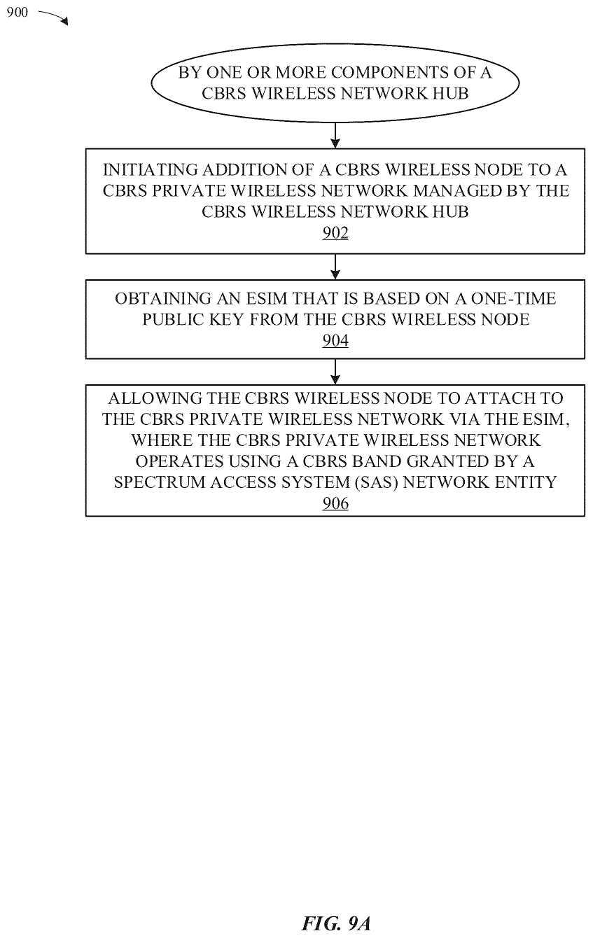

FIGS. 8A and 8B illustrates flow diagrams 800, 820 of another example of adding a wireless node to a CBRS private wireless network 410, where the CBRS wireless node 402 does not have an online cloud-service account with the cloud-network server 502. In this case, the CBRS wireless node 402 does not share a common online cloud-service account with the CBRS wireless network hub 404, as in option A of FIG. 7A, nor does the CBRS wireless node 402 have a separate online cloud-service account with the CBRS wireless network hub, as in option B of FIG. 7A. In this case, the CBRS wireless network hub 404 must use a different procedure to add the CBRS wireless node 402 to the CBRS private wireless network 410. At 802, a user of the CBRS wireless node 402 initiates a procedure to add the CBRS wireless node 402 to the CBRS private wireless network 410 managed by the CBRS wireless network hub 404. The user can initiate addition of the CBRS wireless node 402 by interacting directly with the CBRS wireless network hub 404 or indirectly with the CBRS wireless network hub 404 via the CBRS wireless node 402. At 804, the CBRS wireless network hub 404 and the CBRS wireless node 402 perform a local discovery procedure, e.g., via Wi-Fi, Bluetooth, Near Field Communication (NFC), Wi-Fi Protected Setup (WPS) or the like button, Quick Response (QR) code scan, or the like. The CBRS wireless network hub 404 can obtain information about the CBRS wireless node 402 and can establish a connection for communication between the CBRS wireless network hub 404 and the CBRS wireless node 402.

The process for adding the CBRS wireless node 402 to the CBRS private wireless network 410 can continue via one of two options for generating and provisioning to the CBRS wireless node 402 an eSIM 208 for access to the CBRS private wireless network 410, depending on which entity generates and provisions the eSIM 208. For option E, the eSIM 208 is generated at the CBRS wireless network hub 404, In option F, the eSIM 208 is generated at the cloud-network server 502.

For option E, at 806, when the CBRS wireless network hub 404 requires a range of radio frequencies in the CBRS RF band 302 to use for the CBRS private wireless network 410, the CBRS wireless network hub 404 communicates with a SAS 352 to obtain a grant for a new (or re-use a previous) CBRS band as a CBSD 354. In some embodiments, the CBRS wireless network hub 404 communicates directly with the SAS 352. In some embodiments, the CBRS wireless network hub communicates indirectly with the SAS 352 via a domain proxy 356. In some embodiments, the cloud-network server 502 can serve as the domain proxy 356 for communication with the SAS 352. At 808, the CBRS wireless network hub 404 generates an eSIM 208 for the CBRS wireless node 402, where the eSIM 208 can be included in a protected profile package (PPP).

For option F, the CBRS wireless network hub 404, at 810, sends a message to the cloud-network server 502 requesting that the cloud-network server 502 generate an eSIM 208 for the CBRS wireless node 402 to use to access the CBRS private wireless network 410 managed by the CBRS wireless network hub 404. In some embodiments, the message requesting the eSIM (or a separate message) includes a request to obtain a grant for a new (or re-use a previous) CBRS band for the CBRS wireless network hub 404 to use for the CBRS private wireless network 410, e.g., when the CBRS wireless network hub 404 requires a new (re-use of a previous) CBRS band. At 812, the cloud-network server 502 communicates with the SAS 352 to obtain the CBRS band for the CBRS wireless network hub, when the CBRS wireless network hub 404 requires a new (re-use of a previous) CBRS band. At 814, the cloud-network server 502 generates the eSIM 208 for the CBRS wireless node 402, where the eSIM 208 can be included in a PPP. At 816, the cloud-network server 502 sends to the CBRS wireless node 402 a message that includes the eSIM 208 (in the PPP).

Continuing the procedure for adding the CBRS wireless node 402 to the CBRS private wireless network 410, at 822, the CBRS wireless network hub 404 and the CBRS wireless node 402 perform a common mutual authentication procedure to generate a unique private one-time session key. At 824, the CBRS wireless network hub 404 binds the PPP to a bound profile package (BPP) using the session key. At 826, the CBRS wireless network hub 404 transfers the eSIM 208 (in the BPP) to the CBRS wireless node 402. At 828, the CBRS wireless node extracts the eSIM 208 from the BPP and installs the eSIM 208 on a secure element, e.g., an eUICC 108 or an eSE, of the CBRS wireless node 402. At 830, the CBRS wireless node can use credentials included in the eSIM 208 to attach to the CBRS private wireless network 410 via a CBRS band.

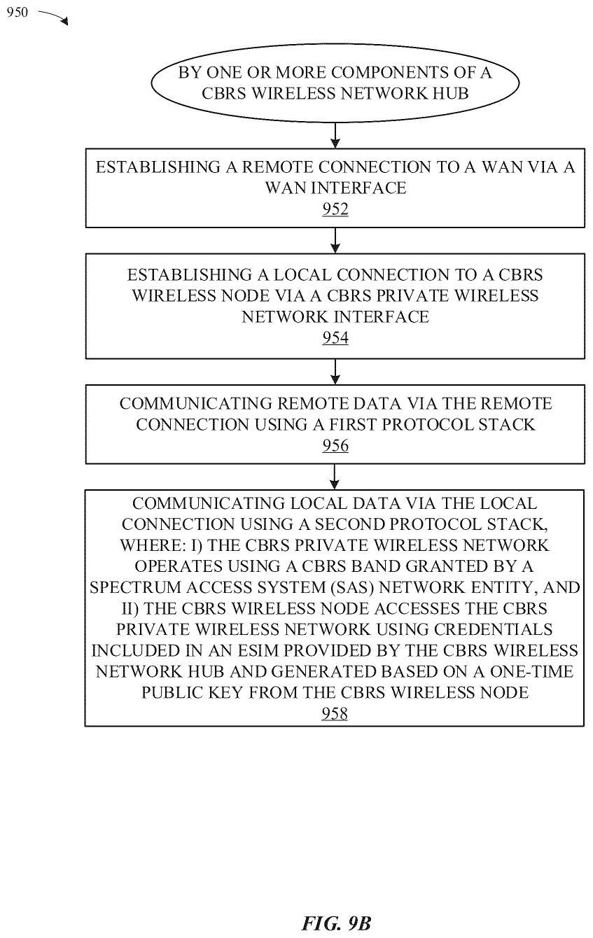

FIG. 9A illustrates a flow chart 900 of an exemplary method performed by one or more components of a CBRS wireless network hub 404 to manage access to a CBRS private wireless network 410. At 902, the one or more components of the CBRS wireless network hub 404 initiate addition of a CBRS wireless node 402 to the CBRS private wireless network 410 managed by the CBRS wireless network hub 404. At 904, the one or more components of the CBRS wireless network hub 404 obtain an eSIM 208 that is based on a one-time public key (otPK) from the CBRS wireless node 402. At 906, the one or more components of the CBRS wireless network hub 404 allow the CBRS wireless node 402 to attach to the CBRS private wireless network 410 via credentials included in the eSIM 208, where the CBRS private wireless network 410 operates using a CBRS band granted by a spectrum access system (SAS) 352 network entity.

In some embodiments, the one or more components of the CBRS wireless network hub 404 obtain the eSIM 208 by generating the eSIM 208 using the otPK. In some embodiments, the one or more components of the CBRS wireless network hub 404 provide the eSIM 208 to a cloud-network server 502 to forward to the CBRS wireless node 402. In some embodiments, the one or more components of the CBRS wireless network hub 404 obtain the eSIM 208 by: i) sending, to a cloud-network server 502, a request for the eSIM 208, and ii) receiving the eSIM 208 from the cloud-network server 502 responsive to the request for the eSIM 208. In some embodiments, the CBRS wireless node 402 and the CBRS wireless network hub 404 are associated with a common cloud-network service account managed by the cloud-network server 502, and the method performed by the one or more components of the CBRS wireless network hub 404 includes the one or more components of the CBRS wireless network hub: i) confirming the CBRS wireless node 402 is included in a list of devices, associated with the common cloud-network service account, obtained from the cloud-network server 502, and ii) providing to the cloud-network server 502 an indication of the CBRS wireless node 402 to be added to the CBRS private wireless network 410. In some embodiments, the CBRS wireless node 402 and the CBRS wireless network hub 404 are associated with different cloud-network service accounts managed by the cloud-network server 502, and the method performed by the one or more components of the CBRS wireless network hub 404 further includes the one or more components of the CBRS wireless network hub 404 providing, to the cloud-network server 502, an indication of a cloud-network service account associated with the CBRS wireless node 402. In some embodiments, the CBRS wireless node 402 is not associated with a cloud-network service account managed by the cloud-network server 502, and the method performed by the one or more components of the CBRS wireless network hub 404 further includes the one or more components of the CBRS wireless network hub 404: i) performing a local wireless network discovery procedure to obtain information regarding the CBRS wireless node 402, ii) obtaining the eSIM 208 from cloud-network server 502 when the eSIM 208 is generated by the cloud-network server 502, iii) performing a mutual authentication procedure with the CBRS wireless node 402 to generate a session key, and iv) binding the eSIM 208 into a bound profile package (BPP) using the session key, wherein the eSIM 208 is transferred to the CBRS wireless node 402 via the BPP. In some embodiments, the method performed by the one or more components of the CBRS wireless network hub 404 further includes the one or more components of the CBRS wireless network hub 404 obtaining, from the SAS 352 network entity, a grant for a new CBRS band to use for the CBRS private wireless network 410, when the CBRS private wireless network 410 requires a newly granted CBRS band. In some embodiments, the method performed by the one or more components of the CBRS wireless network hub 404 further includes the one or more components of the CBRS wireless network hub 404 sending, to the CBRS wireless node 402, a request to delete the eSIM 208 responsive to a user initiating removal of the CBRS wireless node 402 from the CBRS private wireless network 410. In some embodiments, the method performed by the one or more components of the CBRS wireless network hub 404 further includes the one or more components of the CBRS wireless network hub 404 sending, to the SAS 352 network entity, an indication of an empty state of the CBRS band granted for the CBRS private wireless network 410, when no CBRS wireless nodes 402 are associated with the CBRS private wireless network 410 after removal of a most recent CBRS wireless node 402 from the CBRS private wireless network 410. In some embodiments, the method performed by the one or more components of the CBRS wireless network hub 404 further includes the one or more components of the CBRS wireless network hub 404 storing the eSIM 208 at the CBRS wireless network hub 404 for subsequent re-use after deletion of the eSIM 208 from the CBRS wireless node 402 and subsequent removal of the CBRS wireless node 402 from the CBRS private wireless network 410.

FIG. 9B illustrates a flowchart 950 of another exemplary method performed by one or more components of a CBRS wireless network hub 404, where the CBRS wireless network hub 404 is configured for interconnecting a CBRS private wireless network 410 with a wide area network (WAN). At 952, one or more components of the CBRS wireless network hub 404 establishes a remote connection to a WAN via a WAN interface. At 954, the one or more components of the CBRS wireless network hub 404 establish a local connection to a CBRS wireless node 402 via a CBRS private wireless network interface. At 956, the one or more components of the CBRS wireless network hub 404 communicate remote data via remote connection using a first protocol stack. At 958, the one or more components of the CBRS wireless network hub 404 communicate local data using a second protocol stack, where: i) the CBRS private wireless network 410 operates using a CBRS band granted by an SAS network entity 352, and ii) the CBRS wireless node 402 accesses the CBRS private wireless network 410 using credentials included in an eSIM 208 provided by the CBRS wireless network hub 404 and generated based on a one-time public key (otPK) from the CBRS wireless node 402.

In some embodiments, a CBRS wireless network hub 404 is configured for interconnecting a CBRS private wireless network 410 with a wide area network (WAN). The CBRS wireless network hub 404 includes: i) a WAN interface, ii) a CBRS private wireless network interface, and iii) one or more processors communicatively coupled to the WAN interface and the CBRS private wireless network interface. The CBRS wireless network hub 404 is configured to: i) establish a remote connection to a WAN via the WAN interface, ii) establish a local connection to a CBRS wireless node 402 via the CBRS private wireless network interface, iii) communicate remote data via the remote connection using a first protocol stack, and iv) communicate local data via the local connection using a second protocol stack. The CBRS private wireless network 410 operates using a CBRS band granted by an SAS 352 network entity. The CBRS wireless node 402 access the CBRS private wireless network 410 using credentials included in an e SIM 208 provided by the CBRS wireless network hub 404 and generated based on a one-time public key (otPK) from the CBRS wireless node 402.

In some embodiments, the local connection between the CBRS wireless network hub 404 and the CBRS wireless node 402 includes a cellular wireless connection, and the second protocol stack includes a cellular protocol stack. In some embodiments, the remote connection between the CBRS wireless network hub 404 and the WAN includes a cellular wireless connection, and the first protocol stack includes a cellular protocol stack. In some embodiments, the remote connection between the CBRS wireless network hub 404 and the WAN includes a broadband wired connection, and the first protocol stack includes a non-cellular protocol stack. In some embodiments, the CBRS wireless network hub 404 is further configured to: i) operate as a termination end point for internet data traffic received via the remote connection to the WAN, and ii) operate as a cellular access point to the CBRS wireless node 402. In some embodiments, the CBRS wireless network hub 404 is further configured to: i) establish a second local connection to a second CBRS wireless node 402 via the CBRS private wireless network interface, and ii) route local data traffic between the CBRS wireless node 402 and the second CBRS wireless node 402 connected to the CBRS private wireless network via the second protocol stack. In some embodiments, the CBRS wireless network hub 404 is further configured to: i) multiplex remote data traffic received via the local connection from the CBRS wireless node 402 and via the second local connection from the second CBRS wireless node 402 via the second protocol stack, and ii) communicate the multiplexed remote data traffic via the remote connection to the WAN via the first protocol stack. In some embodiments, the CBRS wireless network hub 404 is further configured to: i) de-multiplex remote data traffic received via the remote connection from the WAN via the first protocol stack, and ii) communicate the de-multiplexed remote data traffic via the local connection to the CBRS wireless node 402 and via the second local connection to the second CBRS wireless node 402 via the second protocol stack.

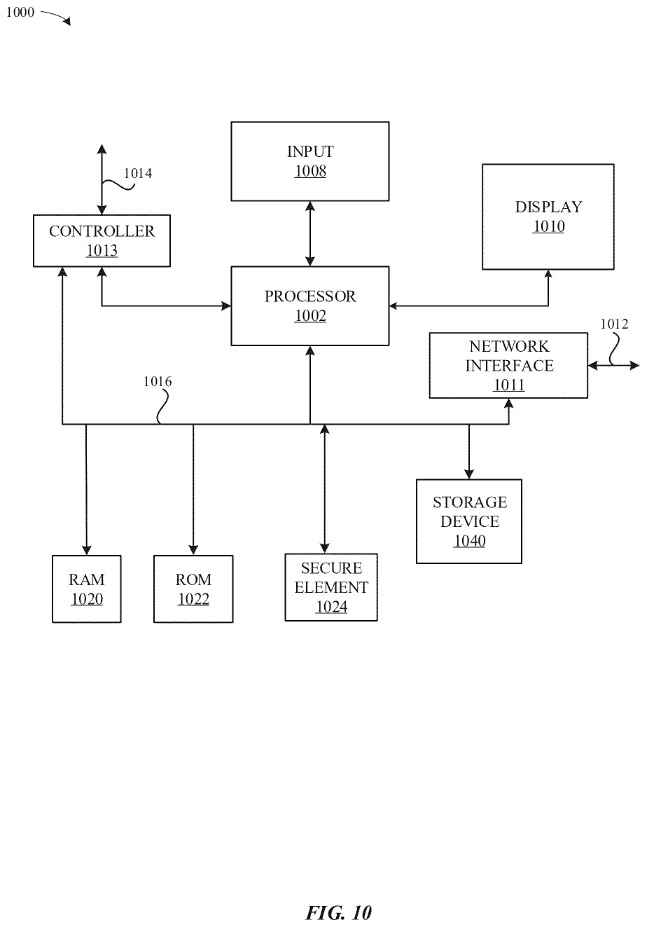

FIG. 10 illustrates a detailed view of a representative computing device 1000 that can be used to implement various methods described herein, according to some embodiments. In particular, the detailed view illustrates various components that can be included in the wireless device 102, a CBRS device (CBSD) 354, a CBRS wireless network hub 404, a CBRS wireless node 402, or any other wireless device as discussed herein. As shown in FIG. 10, the computing device 1000 can include a processor 1002 that represents a microprocessor or controller for controlling the overall operation of computing device 1000. The computing device 1000 can also include a user input device 1008 that allows a user of the computing device 1000 to interact with the computing device 1000. For example, the user input device 1008 can take a variety of forms, such as a button, keypad, dial, touch screen, audio input interface, visual/image capture input interface, input in the form of sensor data, etc. Still further, the computing device 1000 can include a display 1010 that can be controlled by the processor 1002 to display information to the user. A data bus 1016 can facilitate data transfer between at least a storage device 1040, the processor 1002, and a controller 1013. The controller 1013 can be used to interface with and control different equipment through an equipment control bus 1014. The computing device 1000 can also include a network/bus interface 1011 that communicatively couples to a data link 1012. In the case of a wireless connection, the network/bus interface 1011 can include a wireless transceiver.

The computing device 1000 also includes a storage device 1040, which can comprise a single disk or a plurality of disks (e.g., hard drives), and includes a storage management module that manages one or more partitions within the storage device 1040. In some embodiments, storage device 1040 can include flash memory, semiconductor (solid state) memory or the like. The computing device 1000 can also include a Random Access Memory (RAM) 1020 and a Read-Only Memory (ROM) 1022. The ROM 1022 can store programs, utilities or processes to be executed in a non-volatile manner. The RAM 1020 can provide volatile data storage, and stores instructions related to the operation of the computing device 1000. The computing device 1000 can further include a secure element (SE) 1024, which can represent secure storage for credentials for cellular wireless system access by the computing device 1000. The secure element 1024 can include an eUICC 108 on which to store one or more eSIMs 208, one or more UICCs 118 that store SIM or eSIM credentials (profiles), and/or a processor and/or chip component in a system on chip (SoC) module that stores iSIM credentials (profiles).

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable.

Cellular wireless access credentials to provide access to cellular wireless services of a cellular wireless service provider can be installed in a wireless device in a variety of forms including but not limited to a universal integrated circuit card (UICC) storing a subscriber identity module (SIM), an embedded UICC (eUICC) storing an electronic SIM (eSIM), or in hardware, such as a processor of system on chip (SoC) module storing an integrated SIM (iSIM). The embodiments described herein can apply to all of these type of implementations. A UICC storing a SIM can also be referred to as a SIM card. A SIM, eSIM, or iSIM can also be referred to as a SIM profile, an eSIM profile, or an iSIM profile respectively, or simply as a profile.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for managing access to a Citizens Band Radio Service (CBRS) private wireless network managed by a CBRS wireless network hub, the method comprising:
by one or more components of the CBRS wireless network hub:
initiating addition of a CBRS wireless node to the CBRS private wireless network managed by the CBRS wireless network hub;
obtaining an electronic subscriber identity module (eSIM) that is generated based on a one-time public key (otPK) from the CBRS wireless node; and
allowing the CBRS wireless node to attach to the CBRS private wireless network via the eSIM,
wherein the CBRS private wireless network operates using a CBRS band granted by a spectrum access system (SAS) network entity.

2. The method of claim 1, wherein the CBRS wireless network hub obtains the eSIM by generating the eSIM using the otPK.

3. The method of claim 2, further comprising:
by the one or more components of the CBRS wireless network hub:
providing, to a cloud-network server, the eSIM to forward to the CBRS wireless node.

4. The method of claim 1, wherein obtaining the eSIM comprises:
sending, to a cloud-network server, a request for the eSIM; and
receiving the eSIM from the cloud-network server responsive to the request for the eSIM.

5. The method of claim 4, wherein:
the CBRS wireless node and the CBRS wireless network hub are associated with a common cloud-network service account managed by the cloud-network server; and
the method performed by the one or more components of the CBRS wireless network hub further includes:
confirming the CBRS wireless node is included in a list of devices, associated with the common cloud-network service account, obtained from the cloud-network server; and
providing to the cloud-network server an indication of the CBRS wireless node to be added to the CBRS private wireless network.

6. The method of claim 4, wherein:
the CBRS wireless node and the CBRS wireless network hub are associated with different cloud-network service accounts managed by the cloud-network server; and
the method performed by the one or more components of the CBRS wireless network hub further includes:
providing, to the cloud-network server, an indication of a cloud-network service account associated with the CBRS wireless node.

7. The method of claim 4, wherein:
the CBRS wireless node is not associated with a cloud-network service account managed by the cloud-network server; and
the method performed by the one or more components of the CBRS wireless network hub further includes:
performing a local wireless network discovery procedure to obtain information regarding the CBRS wireless node;
obtaining the eSIM from cloud-network server when the eSIM is generated by the cloud-network server;
performing a mutual authentication procedure with the CBRS wireless node to generate a session key; and
binding the eSIM into a bound profile package (BPP) using the session key, wherein the eSIM is transferred to the CBRS wireless node via the BPP.

8. The method of claim 1, further comprising:
by the one or more components of the CBRS wireless network hub:
obtaining, from the SAS network entity, a grant for a new CBRS band to use for the CBRS private wireless network, when the CBRS private wireless network requires a newly granted CBRS band.

9. The method of claim 1, further comprising:
by the one or more components of the CBRS wireless network hub:
sending, to the CBRS wireless node, a request to delete the eSIM responsive to a user initiating removal of the CBRS wireless node from the CBRS private wireless network.

10. The method of claim 1, further comprising:
by the one or more components of the CBRS wireless network hub:
sending, to the SAS network entity, an indication of an empty state of the CBRS band granted for the CBRS private wireless network, when no CBRS wireless nodes are associated with the CBRS private wireless network after removal of a most recent CBRS wireless node from the CBRS private wireless network.

11. The method of claim 1, further comprising:
by the one or more components of the CBRS wireless network hub:
storing the eSIM at the CBRS wireless network hub for subsequent re-use after deletion of the eSIM from the CBRS wireless node and subsequent removal of the CBRS wireless node from the CBRS private wireless network.

12. A Citizens Band Radio Service (CBRS) wireless network hub configured for managing access to a CBRS private wireless network, the CBRS wireless network hub comprising:
wireless circuitry comprising one or more antennas; and
one or more processors communicatively coupled to the wireless circuitry and to a memory storing instructions that, when executed by the one or more processors, cause the CBRS wireless network hub to perform actions including:
initiating addition of a CBRS wireless node to the CBRS private wireless network managed by the CBRS wireless network hub;
obtaining an electronic subscriber identity module (eSIM) that is generated based on a one-time public key (otPK) from the CBRS wireless node; and
allowing the CBRS wireless node to attach to the CBRS private wireless network via the eSIM,
wherein the CBRS private wireless network operates using a CBRS band granted by a spectrum access system (SAS) network entity.

13. The CBRS wireless network hub of claim 12, wherein:
the CBRS wireless network hub obtains the eSIM by generating the eSIM using the otPK; and
the CBRS wireless network hub is further configured to provide the eSIM to a cloud-network server to forward to the CBRS wireless node.

14. The CBRS wireless network hub of claim 12, wherein the CBRS wireless network hub obtains the eSIM by:
sending, to a cloud-network server, a request for the eSIM; and
receiving the eSIM from the cloud-network server responsive to the request for the eSIM.

15. The CBRS wireless network hub of claim 14, wherein:
the CBRS wireless node and the CBRS wireless network hub are associated with a common cloud-network service account managed by the cloud-network server; and
the CBRS wireless network hub is further configured to:
confirm the CBRS wireless node is included in a list of devices, associated with the common cloud-network service account, obtained from the cloud-network server; and
provide to the cloud-network server an indication of the CBRS wireless node to be added to the CBRS private wireless network.

16. The CBRS wireless network hub of claim 14, wherein:
the CBRS wireless node and the CBRS wireless network hub are associated with different cloud-network service accounts managed by the cloud-network server; and
the CBRS wireless network hub is further configured to:
provide, to the cloud-network server, an indication of a cloud-network service account associated with the CBRS wireless node.

17. The CBRS wireless network hub of claim 14, wherein:
the CBRS wireless node is not associated with a cloud-network service account managed by the cloud-network server; and
the CBRS wireless network hub is further configured to:
perform a local wireless network discovery procedure to obtain information regarding the CBRS wireless node;
obtain the eSIM from cloud-network server when the eSIM is generated by the cloud-network server;
perform a mutual authentication procedure with the CBRS wireless node to generate a session key; and
bind the eSIM into a bound profile package (BPP) using the session key, wherein the eSIM is transferred to the CBRS wireless node via the BPP.

18. The CBRS wireless network hub of claim 12, wherein CBRS the wireless network hub is further configured to:
obtain, from the SAS network entity, a grant for a new CBRS band to use for the CBRS private wireless network, when the CBRS private wireless network requires a newly granted CBRS band.

19. The CBRS wireless network hub of claim 12, wherein the CBRS wireless network hub is further configured to:
send, to the CBRS wireless node, a request to delete the eSIM responsive to a user initiating removal of the CBRS wireless node from the CBRS private wireless network.

20. A Citizens Band Radio Service (CBRS) wireless network hub configured for interconnecting a CBRS private wireless network to a wide area network (WAN), the CBRS wireless network hub comprising:
a WAN interface;
a CBRS private wireless network interface; and
one or more processors communicatively coupled to the WAN interface and the CBRS private wireless network interface, where the CBRS wireless network hub is configured to:
establish a remote connection to a WAN via the WAN interface;
establish a local connection to a CBRS wireless node via the CBRS private wireless network interface;
communicate remote data via the remote connection using a first protocol stack; and
communicate local data via the local connection using a second protocol stack, wherein:
the CBRS private wireless network operates using a CBRS band granted by a spectrum access system (SAS) network entity; and
the CBRS wireless node accesses the CBRS private wireless network using credentials included in an electronic subscriber identity module (eSIM) provided by the CBRS wireless network hub and generated based on a one-time public key (otPK) from the CBRS wireless node.
